(19) United States
(12) Patent Application Publication
(10) Pub. No.: US 2015/0312176 A1
(43) Pub. Date: Oct. 29, 2015

(54) Instant Messaging Systems and Methods

(71) Applicant: Barclays Bank PLC, London (GB)

(72) Inventors: Amanda Marie Jones, New York, NY (US); Paul Henry Arthur Peard, Rochester (GB)

(21) Appl. No.: 14/691,637

(22) Filed: Apr. 21, 2015

Related U.S. Application Data
(60) Provisional application No. 61/983,604, filed on Apr. 24, 2014.

(51) Int. Cl. H04L 12/58; H04L 29/08; H04L 29/06

(52) U.S. Cl. CPC H04L 51/04; H04L 65/403; H04L 67/10

(57) ABSTRACT

Data describing a request to obtain access to an instant messaging system is received from a requesting device. The request to obtain access includes an identifier. A plugin is identified from a data repository based on the identifier in the request. The plugin is adapted to extend an instant messaging application installed on the requesting device. In some aspects, the plugin received during an instant messaging session extends the instant messaging application until the instant messaging session is terminated.

### CROSS REFERENCE TO RELATED APPLICATIONS

This application claims priority to U.S. Provisional Patent Application No. 61/983,604 filed Apr. 24, 2014, which is hereby incorporated by reference in its entirety.

### FIELD OF THE INVENTION

The present invention generally relates to the field of messaging communication systems and, more specifically, instant messaging applications.

### SUMMARY OF THE DESCRIBED EMBODIMENTS

Embodiments of the invention are now described which include computerized methods, computer systems, and non-transitory computer readable storage media having stored thereon computer-executable instructions which, when executed by a processor, perform the recited methods.

In connection with one aspect of the invention, data describing a request to obtain access to an instant messaging system is received from a requesting device. The request to obtain access includes an identifier. A plugin is identified from a data repository based on the identifier in the request. The plugin is adapted to extend an instant messaging application installed on the requesting device. The identifier may comprise data describing an end user. In a further aspect, data describing the plugin is received at the requesting device. In a still further aspect, the instant messaging application is extended using the plugin. In some aspects, the plugin received during an instant messaging session extends the instant messaging application until the instant messaging session is terminated.

In some aspects of the invention, data is received, where the data describes a request from a requesting device to access data describing messages initiated by one or more devices in connection with a message transmission channel implemented in an instant messaging application. The request includes an identifier. A plugin is identified from a data repository based on the identifier in the request. The plugin is adapted to extend the instant messaging application installed on the requesting device. In certain aspects, the request is a request to receive data describing messages initiated by a counterparty device. The data describing the messages initiated by the counterparty device are associated with a counterparty identifier. In some aspects, the identifier comprises data describing a counterparty. The identifier may also comprise data describing an address associated with the message transmission channel. The identifier may also comprise data describing a user of the requesting device. Still further, the identifier may comprise data describing the requesting device executing the instant messaging application. Embodiments may further comprise receiving data describing the plugin at the requesting device, and extending the instant messaging application using the plugin. The plugin may extend the instant messaging application until access to data describing messages initiated by the one or more devices in connection with the message transmission channel is terminated.

In further embodiments, data describing a request to obtain access to an instant messaging system is transmitted from a requesting device, where the request to obtain access includes an identifier. The requesting device receives a plugin identified from a data repository based on the identifier in the request. An instant messaging application installed on the requesting device is extended based on the plugin. The identifier may comprise data describing an end user. The plugin received during an instant messaging session may extend the instant messaging application until the instant messaging session is terminated.

In still further embodiments, data is transmitted from a requesting device. The data describes a request to access data describing messages initiated by one or more devices in connection with a message transmission channel implemented in an instant messaging application. The request includes an identifier. Received at the requesting device is a plugin identified from a data repository based on the identifier in the request. The instant messaging application installed on the requesting device is extended at the requesting device. In some embodiments, the request is a request to receive data describing messages initiated by a counterparty device and wherein the data describing the messages initiated by the counterparty device are associated with a counterparty identifier. The identifier may comprise data describing a counterparty. The identifier may comprise data describing an address associated with the message transmission channel. The identifier may comprise data describing a user of the requesting device. The identifier may comprise data describing the requesting device executing the instant messaging application. In such embodiments, the plugin may extend the instant messaging application until access to data describing messages initiated by the one or more devices in connection with the message transmission channel is terminated.

In some embodiments, data describing a request to retrieve a plugin associated with an instant messaging application from a data repository is received from a requesting device. Data describing the plugin is transmitted to the requesting device. The plugin is configured to extend the instant messaging application in accordance with a context of at least one of: a user of the instant messaging application, a party to a conversation, a conversation, a conversation type, a conversation member, and an instant messaging backend system. In certain embodiments, the request may include an identifier of the instant message backend system. The plugin may be configured to extend the instant messaging application by extending at least some messages sent or received by the instant messaging application based on an identity of an instant messaging backend system employed to process messages in connection with the instant messaging application. In some embodiments, the request includes an identifier of the user of the instant messaging application. The plugin may be configured to extend the instant messaging application by extending at least some messages sent or received based on an identity of a user of the instant messaging application. In some embodiments, the request includes a conversation type identifier. The plugin may be configured to extend the instant messaging application by extending at least some messages sent or received by the instant messaging application based on a conversation type. The conversation type may be one of: a one-to-one conversation, non-persistent multiparty conversation or persistent multiparty conversation. In some embodiments, the request may include a persistent multiparty conversation identifier. The plugin may be configured to extend the instant messaging application by extending at least some messages sent or received by the instant messaging application based on an identity of a persistent multiparty conversation. In some embodiments, the request includes a persistent multiparty conversation membership identifier. The plugin may be configured to extend the instant messaging application by extending at least some messages sent or received by the instant messaging application for a party in a persistent multiparty conversation based on a membership role of the party in the identified persistent multiparty conversation. The request may include a counterparty identifier associated with the counterparty in the conversation or an identifier of the user of the instant messaging application in the conversation. The plugin may be configured to extend the instant messaging application by extending at least some messages sent or received by the instant messaging application from a counterparty in a conversation.

In some embodiments, data describing a request to retrieve a plugin associated with an instant messaging application executed on the requesting device from a data repository is transmitted from a requesting device. Data describing the plugin is received at the requesting device. The plugin is configured to extend the instant messaging application in accordance with a context of at least one of: a user of the instant messaging application, a party to a conversation, a conversation, a conversation type, a conversation member, and an instant messaging backend system. In some embodiments, the request includes an identifier of the instant message backend system. The plugin may be configured to extend the instant messaging application by extending at least some messages sent or received by the instant messaging application based on an identity of an instant messaging backend system employed to process messages in connection with the instant messaging application. In some embodiments, the request includes an identifier of the user of the instant messaging application. The plugin may be configured to extend the instant messaging application by extending at least some messages sent or received based on an identity of a user of the instant messaging application. In some embodiments, the request may include a conversation type identifier. The plugin is configured to extend the instant messaging application by extending at least some messages sent or received by the instant messaging application based on a conversation type. In some embodiments, the conversation type is one of: a one-to-one conversation, non-persistent multiparty conversation or persistent multiparty conversation. In some embodiments, the request includes a persistent multiparty conversation identifier. The plugin may be configured to extend the instant messaging application by extending at least some messages sent or received by the instant messaging application based on an identity of a persistent multiparty conversation. In some embodiments, the request includes a persistent multiparty conversation membership identifier. The plugin may be configured to extend the instant messaging application by extending at least some messages sent or received by the instant messaging application for a party in a persistent multiparty conversation based on a membership role of the party in the identified persistent multiparty conversation. In some embodiments, the request includes a counterparty identifier associated with the counterparty in the conversation or an identifier of the user of the instant messaging application in the conversation. The plugin may be configured to extend the instant messaging application by extending at least some messages sent or received by the instant messaging application from a counterparty in a conversation.

Some embodiments of the invention involve receiving, from a requesting device, data describing a request to retrieve from a data repository a plugin associated with a conversation using an instant messaging application. Data describing the plugin is transmitted to the requesting device. The plugin is configured to extend the instant messaging application based on an identity of a counterparty in the conversation. The plugin may be configured to extend the instant messaging application by extending at least some messages sent or received by the instant messaging application in the conversation. The request to download the plugin may include a counterparty identifier associated with the counterparty or may include an identifier associated with a user of the instant messaging application.

Other embodiments of the present invention involve transmitting, from a requesting device, data describing a request to retrieve from a data repository a plugin associated with a conversation using an instant messaging application from the data repository and receiving, at the requesting device, data describing the plugin. The plugin is configured to extend the instant messaging application based on an identity of a counterparty in the conversation. In some embodiments, the plugin is configured to extend the instant messaging application by extending at least some messages sent or received by the instant messaging application in the conversation. The request to download the plugin may include a counterparty identifier associated with the counterparty or may include an identifier associated with a user of the instant messaging application.

Some embodiments of the present invention involve receiving data describing a request, from a device, to retrieve data describing an instant message in a data repository. Data describing a record is retrieved from the data repository, the record including the data describing the instant message and a redact indicator. A determination as to whether to redact the data describing the instant message is made based on the redact indicator. Data describing the instant message is transmitted to the device in a redacted state if the redact indicator indicates that the instant message is a redacted instant message and transmitting data describing the instant message to the device in an unredacted state if the redact indicator indicates that the instant message is an unredacted message. If the redact indicator indicates that the message is a redacted message, at least a portion of the instant message is redacted before transmitting data describing the instant message to the device. If the redact indicator indicates that the message is an unredacted message, no portion of the instant message is redacted before transmitting data describing the instant message to the device. In some embodiments, the data repository includes data describing a plurality of records, each of the plurality of records including an instant message and a redact indicator. In certain embodiments, each of the redact indicators corresponds to only one of the instant messages. The redact indicator may include a character offset and a character length used to redact at least a portion of the instant message.

In some embodiments of the invention, data describing an instant message is received, where the instant message includes a meta identifier. An instant message backend system is identified for processing and transmitting the instant message. The instant message backend system is associated with an instant message backend system identifier. The identifying comprises determining whether the meta identifier included with the instant message corresponds to the instant message backend system identifier associated with the instant message backend system. The instant message is converted to a compliant instant message, the compliant instant message being compliant with the instant message backend system. Data describing the compliant instant message is transmitted to the instant message backend system. The meta identifier may comprise a conversation meta identifier. The instant message backend system identifier may comprise an instant message backend system conversation identifier that identifies a conversation hosted by the instant message backend system. The meta identifier may comprise a user meta identifier. The instant message backend system identifier may comprise an instant message backend system user identifier that identifies a user authorized to exchange messages using the instant message backend system. The meta identifier may corresponds to a first user meta identifier that identifies a first user and a second user meta identifier that identifies a second user; the instant message backend system identifier corresponds to a first instant message backend system user identifier identifying the first user and a second instant message backend system identifier identifying the second user. The meta identifier may correspond to a user meta identifier and a conversation meta identifier. The instant message backend system identifier corresponds to a instant message backend system user identifier that identifies a user capable of exchanging messages using the instant message backend system and a instant message backend system conversation identifier that identifies a conversation hosted by the instant message backend system.

In some embodiments, data describing a request to transfer an instant messaging conversation from a first instant message backend system to a second instant message backend system is received. The instant message conversation is transferred from the first instant message backend system to the second instant message backend system. A message associated with the instant messaging conversation is sent to the second instant message backend system. In some embodiments, before the transferring step, it is determined that a meta identifier of each party to the instant message conversation is associated with an instant message backend user identifier for the second instant message backend system. In some embodiments, before the transferring step, it is determined that the instant message conversation is capable of being hosted on the second instant message backend system.

In some embodiments, the instant message conversation on the first instant message backend system has a corresponding first conversation instance in a data repository. In such embodiments, a second conversation instance is created in the data repository. The second conversation instance corresponds to the instant message conversation on the second instant message backend system.

Some embodiments of the invention are directed to a system that includes a container software module that is configured to receive a message from a user interface of a client device for transmission to an instant message backend system, encapsulate the message using an application protocol and transmit the encapsulated message to a messaging core software module. The system also includes a messaging core software module configured to format the encapsulated message into an instant message backend system compliant message using a messaging protocol corresponding to the instant message backend system, and transmit the instant message backend system compliant message to the instant message backend system. In the system, the application protocol comprises a hyper text transfer protocol, or a CometD protocol. The messaging core software module may be configured to create a new message transmission channel before transmitting the instant message backend system compliant message. The messaging core software module may be configured to connect to an existing message transmission channel before transmitting the instant message backend system compliant message. The messaging core software module and the container software module may be executable on a same device. In other embodiments, the messaging core software module is executable on a server and the container software module is executable on a device separate from the server.

In some embodiments, a message is received, using a container software module, from a user interface of a client device for transmission to an instant message backend system. Using the container software module, the message is encapsulated using an application protocol and the encapsulated message is transmitted to a messaging core software module. Using the messaging core software module, the encapsulated message is formatted into an instant message backend system compliant message using a messaging protocol corresponding to the instant message backend system. Using the messaging core software module, the instant message backend system compliant message is transmitted to the instant message backend system. The application protocol may comprise a hyper text transfer protocol or a CometD protocol. In some embodiments, using the messaging core software module, a new message transmission channel is created before the transmitting the instant message backend system compliant message. Also, in some embodiments, the messaging core software module is used to connect to an existing message transmission channel before transmitting the instant message backend system compliant message. In some embodiments, the messaging core software module and the container software module may be executable on a same client device. In some embodiments, the messaging core software module is executable on a server and the container software module is executable on a client device.

In certain embodiments, using a container software module, a message is received from a user interface of a client device for transmission to an instant message backend system. Using the container software module, the message is encapsulated using an application protocol. Also using the container software module, the encapsulated message is transmitted to a messaging core software module. Using the messaging core software module, the encapsulated message is formatted into an instant message backend system compliant message using a messaging protocol corresponding to the instant message backend system. Also using the messaging core software module, the instant message backend system compliant message is transmitted to the instant message backend system. The application protocol may comprise a hyper text transfer protocol or a CometD protocol. The embodiment may further comprise creating, using the messaging core software module, a new message transmission channel before transmitting the instant message backend system compliant message. The embodiment may further comprise connecting, using the messaging core software module, to an existing message transmission channel before transmitting the instant message backend system compliant message. In some embodiments, the messaging core software module and the container software module are executable on a same client device. In other embodiments, the messaging core software module is executable on a server and the container software module is executable on a client device.

Some embodiments involve receiving a first message sent in connection with a one-to-one conversation, a second message sent in connection with a multi-party non-persistent conversation and a third message sent in connection with a multi-party persistent conversation. The first message is transmitted to a counterparty associated with the one-to-one conversation, the second message to two or more parties associated with the multi-party non-persistent conversation, and the third message to two or more parties associated with the multi-party persistent conversation using a single instant message backend system configured to host only a subset of: the one-to-one conversation, the multi-party non-persistent conversation and the multi-party persistent conversation. In certain of these embodiments, the first message, the second message and the third message are stored in a database. The first message associated with the one-to-one conversation may be retrievable when at least one party rejoins the one-to-one conversation after either: i) a restart of an instant message service providing the one-to-one conversation or ii) all parties disconnect from the one-to-one conversation. The third message associated with the multiparty persistent conversation may be retrievable when at least one party rejoins the multiparty persistent conversation after either: i) a restart of an instant message service providing the multiparty persistent conversation or ii) all parties disconnect from the multiparty persistent conversation. A party associated with the multiparty non-persistent conversation may be restricted from rejoining the multiparty non-persistent conversation after either: i) a restart of an instant message service providing the multiparty non-persistent conversation or ii) all parties disconnect from the multiparty non-persistent conversation.

Some embodiments include a system that includes an instant message backend system configured to host at most two of: a one-to-one conversation, a multi-party non-persistent conversation and a multi-party persistent conversation; a messaging core configured to receive messages sent in connection with all of a one-to-one conversation, a multi-party non-persistent conversation and a multi-party persistent conversation, and transmit the messages to the instant message backend system; and a database configured to store the messages. In certain embodiments, at least one of the messages associated with the one-to-one conversation is retrievable when at least one party rejoins the one-to-one conversation after either: i) a restart at least one of: the message core and the instant messaging backend system or ii) all parties disconnect from the one-to-one conversation. In other embodiments, the third message associated with the multiparty persistent conversation is retrievable when at least one party rejoins the multiparty persistent conversation after either: i) a restart at least one of: the message core and the instant messaging backend system or ii) all parties disconnect from the multiparty persistent conversation. In other embodiments, a party associated with the multiparty non-persistent conversation is restricted from rejoining the multiparty non-persistent conversation after either: i) a restart at least one of: the message core and the instant messaging backend system or ii) all parties disconnect from the multiparty non-persistent conversation.

Certain embodiments involve receiving a plugin that extends functionality of an instant messaging application installed on a first device; receiving a message from a second device employed by a party using a first communication functionality, the message including a message payload; using the plugin, identifying a portion of the message payload associated with a triggered action; and generating a user interface file to display on a user interface of the first device, the user interface file including a capability to communicate with the party using a second communication functionality selected based on the triggered action. In some embodiments, before the generating, a custom HTML stanza is generated. In other embodiments, the user interface file is generated by modifying a standard user interface file to include the custom HTML stanza. In some embodiments, the first communication functionality comprises text communication functionality and the second communication functionality comprises telephony communication functionality, video conferencing functionality, email functionality, file transfer functionality and/or screen-sharing functionality.

### BRIEF DESCRIPTION OF THE SEVERAL VIEWS OF THE DRAWINGS

The foregoing summary, as well as the following detailed description of embodiments of the invention, will be better understood when read in conjunction with the appended drawings of an exemplary embodiment. It should be understood, however, that the invention is not limited to the precise arrangements and instrumentalities shown.

In the drawings:

FIG. 1 shows a block diagram of a system for allowing users to communicate with one another via electronic messages transmitted over a network according to at least one embodiment of the invention.

FIG. 2 shows a flow diagram for processing and transmitting a message to an instant message (“IM”) backend system hosting a conversation according to at least one embodiment of the invention.

FIG. 3 shows a flow diagram for receiving, transmitting, storing and retrieving messages for different conversations using a single IM backend system according to at least one embodiment of the invention.

FIG. 4 shows a flow diagram for a method of transferring a conversation hosted by a first IM backend system to a second IM backend system according to at least one embodiment of the invention.

FIG. 5 shows a flow diagram for a method of transmitting a message using a container and a messaging core according to at least one embodiment of the invention.

FIG. 6 shows a flow diagram for a method of dynamically delivering an instant messaging user interface extension to client device according to at least one embodiment of the invention.

FIG. 7 shows a flow diagram for a method of processing an outgoing message using plugins in an instant messaging context according to at least one embodiment of the invention.

FIG. 8 shows a flow diagram for a method of processing an incoming message using plugins in an instant messaging context according to at least one embodiment of the invention.

FIG. 9 shows a flow diagram for a method of generating a user interface presenting a communication functionality using a plugin according to at least one embodiment of the invention.

FIG. 10 shows a flow diagram for a method of redacting message history according to at least one embodiment of the invention.

### DETAILED DESCRIPTION

Embodiments of the invention allow users to communicate with one another in real-time by exchanging electronic messages over a communications network (e.g. the internet). In one embodiment, an electronic message is an instant message (i.e. real-time text transmission).

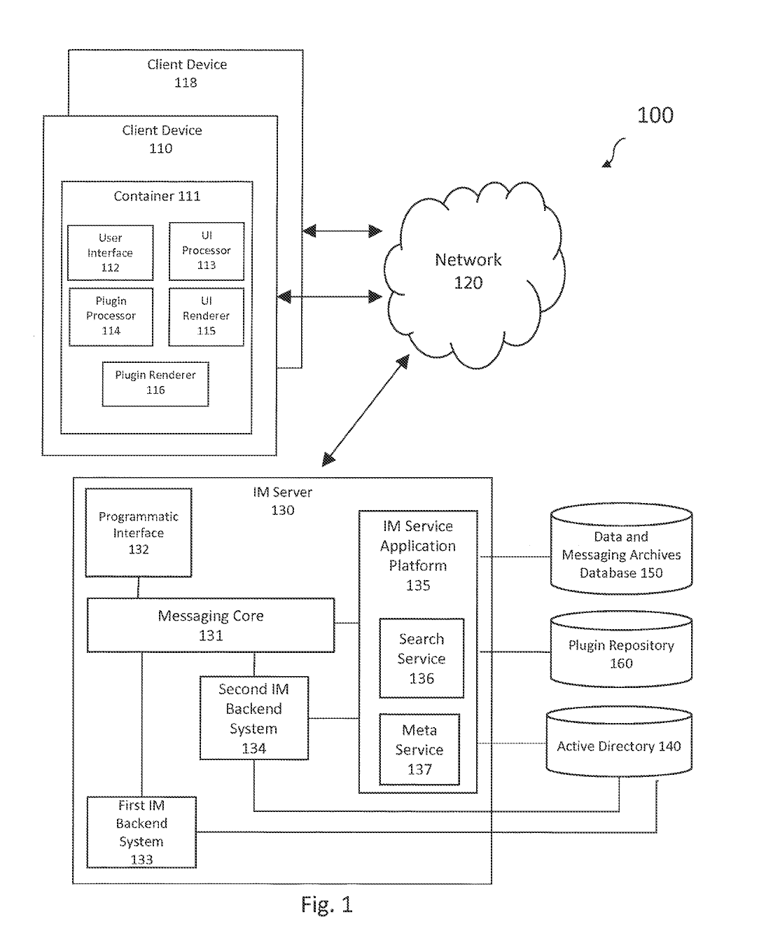

Referring to the drawings in detail, wherein like reference numerals indicate like elements throughout, there is shown in FIGS. 1-10, system 100 and methods used in connection with allowing users to communicate with one another via electronic messages transmitted over a network in according to at least one embodiment of the invention.

I. Exemplary System Architecture

A. General Description

Referring to FIG. 1, there is shown a block diagram of the system 100 for allowing users to communicate with one another via electronic messages transmitted over a network according to at least one embodiment of the invention. System 100 includes client device 110, client device 118, communications network 120, instant messaging (IM) server 130, account active directory 140, data and messaging database 150, and plugin repository 160.

Client device 110 communicates with client device 118 through communications network 120 and IM server 130, which hosts an instant messaging service. Messages sent between a first client device, e.g. client device 110, and a second client device, e.g. client device 118, are exchanged between the devices by way of IM server 130. For example, IM server 130 receives a message sent from client device 110 and transmits the message to client device 118 and vice versa. Communications between client device 110, client device 118 and IM server 130 occur via communications network 120 using one or more communication protocols, such as transmission control protocol/Internet Protocol (TCP/IP), for example.

Client device 110 and client device 118 may be any computing device, such as a phone, tablet, computer, smart phone, or a smart device, and may implement similar functionality. Client device 110 and client device 118 each include a container 111 and a user interface 112 for facilitating communication with one another. Container 111 is a platform-native application with the ability to render HyperText Markup Language (HTML), Cascading Style Sheets (CSS) and JavaScript content on user interface 112. “Platform-native” refers to an application written to run on a specific operating system (OS) platform rather than a generic OS platform or web based application. User interface 112 is a program that controls a display (not shown) of a client device, such as client device 110, and that allows a user to interact with IM server 130. Client device 110 and client device 118 transmit messages to IM server 130 using CometD, in one embodiment. CometD is a scalable HTTP-based event routing protocol that uses AJAX push technology. It is contemplated that any and all functionality in client device 110, as well as any and all interactions with IM server 130 by client device 110, may also be included in client device 118 or performed by client device 118.

IM server 130 is configured to receive electronic communications from a first client device, e.g. client device 110, related to the instant messaging service and transmit electronic communications to the first client device, e.g. client device 110 or a second client device, e.g. client device 118. Electronic communications from client device 110 to IM server 130, and vice versa, may include (i) a login request to access to the instant messaging service, (ii) a request to create or join a conversation (examples of the different types of conversations being described below), (iii) an electronic message to be sent to other client devices associated with an instant messaging conversation, and (iv) plugins. To implement the above functionality, IM server 130 includes a messaging core 131, programmatic interface 132, one or more IM backend systems, such as first IM backend system 133 (e.g., such as that available from MindAlign, by way of example), and second IM backend system 134 (e.g., such as XCP), and IM service application platform 135.

Messaging core 131 is an application that provides a number of different capabilities to IM server 130.

Messaging core 131 is also configured to receive a request to join a conversation from a first client device, e.g. client device 110. As referred to herein, a “conversation” refers to an exchange of messages between or among client devices through IM server 130. Such messages in a “conversation” are associated with an address on IM server 130, such as a URL, and identified by a conversation meta identifier. Thus, messages associated with a conversation are sent to and received from the same address, e.g., URL. Further, the conversation meta identifier (along with any corresponding IM backend system conversation identifiers, if necessary) is used to identify a specific conversation for exchanging messages transmitted over a communication network using an IM backend system, such as first IM backend system 133 or second IM backend system 134. Second IM backend system 134 and first IM backend system 133 each represent different IM backend systems for hosting conversations and exchanging messages between users.

A conversation may be a one-to-one conversation which involves an exchange of instant messages between two participants (e.g., a party and a counterparty). A one-to-one conversation may be a persistent conversation. A persistent conversation means all messages associated with a conversation are stored and retrievable when at least one party rejoins the conversation after either: i) a restart of the IM service or ii) all parties disconnect from the conversation, and the conversation can be then be continued or resumed after retrieval of the messages. A conversation may also be a non-persistent multiparty conversation which involves an exchange of instant messages, over a particular or designated message transmission channel, among three or more participants initially, where the conversation is terminated once all of the participants leave the conversation (i.e., the conversation is transitive in that it is only accessible during the time parties are participating). Some of the participants may leave or join the non-persistent multiparty conversation while conversation is accessible.

A conversation may also be a persistent multiparty conversation (e.g., commonly referred to as a “chat room”), which involves an exchange of instant messages, over a particular or designated message transmission channel, among three or more participants initially, where any and all participants can join, leave and rejoin the conversation without terminating the conversation (i.e., the conversation remains accessible even though no participants are participating in the conversation).

A non-persistent conversation means all messages associated with the non-persistent conversation are not retrievable because all parties are restricted from rejoining a non-persistent conversation after either: i) a restart of the IM service or ii) all parties disconnect from the conversation. Instead, a new non-persistent conversation must be created. Users may still access and retrieve messages associated with a non-persistent conversation by searching for messages in data and messaging archives 150.

Some generalities regarding implementation of IM/chat sessions apply to the description herein. For example, a message sent by a participant in a conversation is displayed to all participants. A “channel” is synonymous with a conversation. A “session” refers to an individual client device's connection to a particular IM backend system for a particular conversation. The session is stored on messaging core 131 in local memory. The session is accessible via a meta conversation identifier or an IM backend system conversation identifier associated with the session.

After a first client device (e.g. client device 110) has joined a conversation, messaging core 131 is configured to receive an electronic message from the first client device, process and transmit an XMPP message to second IM backend system 134 (e.g. an IM backend system), receive an XMPP message from second IM backend system 134, and deliver UI rendering code to a second client device, e.g. client device 118, that has already joined the conversation. UI rendering code may include HTML, CSS and/or JavaScript code, by way of example. XMPP messages are messages transmitted via Extensible Messaging and Presence Protocol (XMPP) for message-oriented middleware based on XML (Extensible Markup Language). Second IM backend system 134 is configured to operate as an instant messaging transfer protocol for processing XMPP messages from client device 110 via messaging core 131.

Even though second IM backend system 134 may communicate using XMPP, first IM backend system 133 may communicate using a different protocol, such as internet relay chat (IRC).

Second IM backend system 134 may be configured to federate with other XMPP-based systems. Federation, in the context of IM systems, refers to a connection between discrete, separate systems that allows users of one IM backend system to communicate with users of another IM backend system.

Messaging core 131 may be configured to support multiple concurrent connections from different client devices, each of the client devices capable of being associated with the same user or different users. Messaging core 131 may be multi-tenanted, meaning more than one user and/or client device can use the messaging core 131 at the same time.

Different embodiments of the invention may have multiple messaging cores. In these embodiments, each messaging core may be configured to communicate with one or more client devices (e.g. client device 110 or client device 118). An IM backend system may have many connections with the multiple messaging cores. In addition, similar to messaging core 131, second IM backend system 134 may support connections from many multi-tenanted messaging cores concurrently.

Messaging core 131 also includes a programmatic interface 132 for leveraging APIs exposed in the messaging core.

Messaging core 131 further provides a client device with the capability to connect to multiple backend instant messaging systems such as first IM backend system 133 and second IM backend system 134. Users must have individual accounts provisioned in the meta service 137 for first IM backend system 133 and second IM backend system 134 in order to communicate with other users on the respective IM backend system. First IM backend system 133 may include connections to distinct client applications or user interfaces as well as connections to the messaging core 131. The distinct client applications connected to first IM backend system 133 allow an end user to communicate or exchange messages with other end users using only first IM backend system 133.

Messaging core 131 and at least some of the IM backend systems (e.g. second IM backend system 134) interface with IM service application platform 135 for accessing data and messaging archives database 150 and plugin repository 160, among other things. IM service application platform 135 includes a search service 136 for accessing data and messaging archives database 150. Data and messaging archives database 150 stores user and chat room information (name, owner, business unit, region etc.) and IM backend system identities (paul@companyA, aRoom@companyB, etc.) that associate a user meta identifier or conversation meta identifier to an appropriate IM backend system. Data and messaging archives database 150 also contains conversation history for conversations that have taken place on an IM backend system (e.g. second IM backend system 134). Client devices may request searches on data and messaging archives database 150 for information related to the user, chat room information and the history associated with rooms or conversations between individuals. Data and messaging archives database 150 contains a table of messages that have been sent by users using IM server 130. The data and messaging archives database 150 table may be purged of messages after a defined date to keep the storage required by the database to a manageable level. The messages stored in the database can be used by IM server 130 to provide previous conversation context when a user joins an existing multiparty persistent or one-to-one conversation or rejoins a conversation after a period of time.

Search service 136 responds to a message or element search for the instant messaging service from client device 110 via messaging core 131, retrieves the relevant data from data and messaging archives database 150, and returns a set of results which are provided to the client device 110 via messaging core 131.

IM service application platform 135 also includes meta service 137. Meta service 137 is the administration layer of the plugin repository 160 which controls user configuration, conversation configuration and plugin configuration for the IM service. Plugin repository 160 stores all of the plugins that may be installed on client device 110 to extend (e.g., customize or enhance) the instant messaging service for the user, as described in more detail below. A plugin is an extension to code (e.g., JavaScript user interface code) used by an application (e.g. user interface 112) to display a user interface on a client device.

Meta service 137 may control and process login requests from a client device 110 using account active directory 140. Login requests may be processed using Lightweight Directory Access Protocol (LDAP), an application protocol for accessing and maintaining distributed directory information over an Internet Protocol (IP) network. Directory information includes a list of users authorized to access instant messaging services hosted by IM server 130. First IM backend system 133 and second IM backend system 134 may also access active directory 140 to process login requests.

Container 111 is an application configured to render HTML CSS and JavaScript source code, and to communicate with messaging core 131 using protocols such as the CometD protocol. The container can be a web browser but, in some contexts, container 111 is a dedicated application that provides integration with the operating system on which it is running. For example, if container 111 is a dedicated application, container 111 may be configured to detect if client device 110 is locked, thereby requiring a user login to access client device 110. Container 111, as a dedicated application, may also include access to, or communicate with, additional applications not available to a web browser. For example, if client device 110 had a telephony feature, a web browser may not allow access to the microphone or web-based camera. Container 111, on the other hand, may have access to both the microphone and the web-based camera. Container 111 also includes additional functionality to access system information of the client device or files stored on the client device which can be subsequently sent to messaging core 131. Container 111 may also be able to detect user commands on client device 110, such as when a user is using the keyboard or mouse in another application on client device 110. A web browser, generally, does not provide this functionality. In particular, a web browser, generally, cannot detect the operating system lock state of a client device or allow access to files without user permission. In addition, a web browser, generally, can only detect user activity mouse movements and keyboard actions that occur in the web browser.

Container 111 may include one or more of UI processor 113, plugin processor 114, UI renderer 115 and plugin renderer 116. UI processor 113 processes messages and provides instructions for rendering a standard user interface file, while UI renderer 115 renders, or generates, the user interface file used to generate a display on user interface 112. Plugin processor 114 processes messages and provides instructions for rendering an extended user interface file based on one or more plugins, while plugin renderer 116 renders, or generates, the custom user interface file used to generate a extended display on user interface 112 based on one or more plugins.

Messaging core 131 can be located on the same machine as container 111 and user interface 112 (e.g. client device 110) or hosted as a cloud-based service on IM server 130 and accessed either via a compliant web browser or container 111.

B. Implementation Details of Select Embodiments

1. All Modalities

System 100 provides improvements over conventional IM systems in a number of different ways. One way is that it provides a user with the ability to have multiple types of IM conversations (e.g. one-to-one, multiparty persistent and multiparty non-persistent conversations) with different third parties using a single IM backend system. In some conventional systems, a client-side application may allow a user to have a non-persistent conversation (e.g. multiparty non-persistent conversation) using one IM backend system, but will require a user to access another IM backend system to conduct a persistent conversation (e.g. one-to-one and multiparty persistent conversation). In addition, in some conventional systems, a client-side application may allow a user to have a multiparty conversation using one IM backend system, but will require a user to access another IM backend system to conduct a one-to-one conversation.

By providing a user with the ability to have these three different types of IM conversations via a single IM backend system that does not, by itself, necessarily provide the capability to host all three conversations, system 100 can provide a single seamless user experience for communicating via IM with different parties using the same IM backend system regardless of whether an IM backend system offers persistent vs. non-persistent chat conversations, or multiparty vs. one-to-one conversations. The manner in which this is achieved is as follows.

Initially, a user logs into the system 100 via user interface 112 on client device 110. User interface 112 then transmits a login request to messaging core 131. Messaging core 131 forwards the login request to IM service application platform 135 for further processing.

In some embodiments, after logging in, the user can use a search feature displayed on user interface 112 to request a search of all available parties and any persistent or non-persistent multiparty conversations accessible to the user. The user's ability to access a particular conversation is based on factors such as whether the user and the counterparty, or the user and the others involved in the persistent multiparty conversation, can access and connect to the same IM backend system using their corresponding user access credentials (e.g. IM backend system user identifier). The user request is transmitted to messaging core 131 and subsequently forwarded to IM service application platform 135.

In response to the search request, IM service application platform 135 utilizes search service 136 and meta service 137 to query data and messaging database 150 for all available parties and conversations. The search results returned in response to the search request include a user meta identifier for the user and each available party. The user meta identifier is a unique user identifier associated with the IM service for each party accessing the IM service (e.g. JSmith@IMserver). In addition, for each user meta identifier, the search results also include any IM backend system user identifiers associated with the user meta identifier (e.g. JSmith@firstIMbackendsystem and JSmith@secondIMbackendsystem). A IM backend system user identifier is a unique user identifier associated with the IM backend system (e.g. second IM backend system 134, first IM backend system 133, or other IM backend system) for a user to access conversations hosted by the IM backend system.

The search results also include a conversation meta identifier for each conversation offered by the IM service. The conversation meta identifier is a unique conversation identifier associated with the IM service for each conversation hosted by an IM backend system related to the IM service (e.g. convo1@IMserver or convo2@IMserver). In addition, for each conversation meta identifier, the search results may also include any IM backend system conversation identifiers associated with the conversation meta identifier (e.g. xcpconvol@XCP or maconvol@MindAlign). The IM backend system conversation identifiers are unique conversation identifiers used by one or more IM backend systems (e.g. second IM backend system 134, first IM backend system 133) to exchange messages with different parties for a specific conversation.

The search results also include additional attributes about the user, party or conversation, including any one or more of a name, company, and one or more IM backend system identifiers for each IM backend system (e.g. second IM backend system 134, first IM backend system 133). The search results are transmitted back to messaging core 131.

Messaging core 131 then generates a user interface file to send to user interface 112 including a list of parties and conversations along with their corresponding user or conversation meta identifiers and/or one or more additional attributes. While it is possible that messaging core 131 may send IM backend system user and conversation identifiers as well, messaging core 131 may refrain from transmitting or exposing the IM backend system user and conversation identifiers to the user in order to conceal the fact that multiple IM backend systems are being used. By concealing visibility, messaging core 131 can provide the user with a more seamless user experience while using the IM service. Instead of transmitting the IM backend system user and conversation identifiers, messaging core 131 may store them locally in a database associated with messaging core 131.

a. Joining a Conversation

Once the user interface file is received by user interface 112 and displayed on client device 110, a user may select to join a conversation with a single counterparty (i.e. one-to-one conversation), multiparty non-persistent conversation or an existing chat room (i.e. multiparty persistent conversation) and, possibly, send or receive a message.

After the user selection, user interface 112 retrieves the user meta identifier for the user and the conversation meta identifier for the selected conversation from the previously received user interface file and transmits a request to join the conversation to messaging core 131.

Messaging core 131 receives the request and queries its local database or memory to determine if the user meta identifier for the user and the conversation meta identifier include IM backend system (user or conversation) identifiers to the same IM backend system. By having corresponding IM backend user or conversation identifiers to the same IM backend system, messaging core 131 can determine that the IM backend system can host the conversation. If not, messaging core 131 denies the request to join the conversation and transmits the denial back to the user interface 112 for display on client device 110. Alternatively, messaging core 131 can attempt to transfer the conversation to a new IM backend system as explained below. In this case, messaging core 131 accepts the request to join the conversation and the acceptance is transmitted back to user interface 112 for display on client device 110. Any subsequent messages sent by the user to the selected conversation are then transmitted to the appropriate IM backend system and forwarded to parties that access the multiparty persistent conversation.

b. Creating a Conversation

Alternatively, the user may elect to create a multiparty non-persistent conversation by selecting to begin a conversation with two or more parties or create a one-to one conversation by selecting to begin a conversation with a counterparty.

After the user selection, user interface 112 retrieves the user meta identifiers for the user and all parties from the previously received user interface file and transmits a request to create a multiparty non-persistent conversation or one-to one conversation to messaging core 131.

Messaging core 131 receives the request and queries its local database or memory to determine if all of the user meta identifiers for the user and all parties in the multiparty non-persistent conversation or one-to one conversation include, or are associated with, IM backend user identifiers to the same IM backend system. By having IM backend user identifiers to the same IM backend system, messaging core 131 can determine that the IM backend system can host the conversation. If not, the request to create the multiparty non-persistent conversation or one-to-one conversation is denied and the denial is transmitted back to the user interface 112 for display on client device 110. If so, messaging core 131 sends a request to the IM backend system, such as second IM backend system 134, to create the multiparty non-persistent conversation or one-to one conversation. The request includes an IM backend system user identifier for the user and each party.

If multiple IM backend systems are available, other factors may be used to select an IM backend system. For example, if one IM backend system only processes plain text and another IM backend system processes both plain and rich text, messaging core 131 will select the IM backend system that supports multiple data representations (e.g. both plain and rich text).

After receiving the request from messaging core 131, the IM backend system (e.g. second IM backend system 134) creates an IM backend system conversation identifier and transmits the IM backend system conversation identifier to messaging core 131.

Messaging core 131 then stores the IM backend system conversation identifier and the user meta identifiers of the user and each party associated with the multiparty non-persistent conversation or one-to-one conversation in its local memory as a session.

Messaging core 131 then forwards the IM backend system conversation identifier to all parties associated with the multiparty non-persistent conversation or one-to-one conversation.

Thereafter, any party may send and receive messages associated with the corresponding conversation.

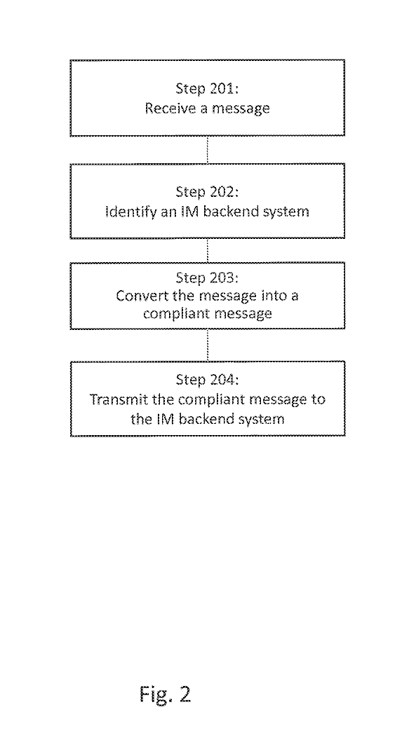

An exemplary implementation of processing and transmitting a message to an IM backend system hosting a conversation is described with reference to FIG. 2.

FIG. 2 shows a flow diagram for processing and transmitting a message to an IM backend system hosting a conversation according to at least one embodiment of the invention.

At step 201, messaging core 131 receives data describing an instant message including a meta identifier.

At step 202, messaging core 131 identifies an instant message backend system for processing and transmitting the instant message. The step of identifying includes determining whether the meta identifier included with the instant message corresponds to an instant message backend system identifier associated with the instant message backend system.

At step 203, messaging core 131 converts the instant message to a compliant instant message that is compliant with the instant message backend system.

At step 204, messaging core 131 transmits data describing the compliant instant message to the instant message backend system.

c. Message History Storage

After each message is retrieved and processed by the corresponding IM backend system, such as second IM backend system 134, the IM backend system, or alternatively messaging core 131, transmits the message to IM service application platform 135 for storage in data and messaging archives 150.

The message is stored as a record with a corresponding key for history retrieval in the future. For one-to-one conversations, the key is the user meta identifiers of the user and the counterparty. For multiparty persistent conversations and multiparty non-persistent conversations, the key is the corresponding conversation meta identifier.

A user may access conversation history by transmitting a request to messaging core 131, where the request includes the key to the corresponding conversation. In some instances, e.g. one-to-one conversations and multiparty persistent conversations, messaging core 131 and IM service application platform 135, rather than the IM backend system, will automatically retrieve the conversation history and transmit the conversation history in a user interface file to the client device 110 when the user requests to rejoin a one-to-one conversation with a counterparty where both users had previously exchanged messages, or in a multiparty persistent conversation, where a user or counterparties have exchanged messages. Message history retrieval is independent of the IM backend system used for past or future conversations, regardless of the type of conversation and regardless of whether the conversation occurred on two different IM backend systems. By providing independent message history retrieval, regardless of which IM backend system is hosting the conversation, the IM service can extend IM backend system that only offer non-persistent conversations to include persistent conversations as well.

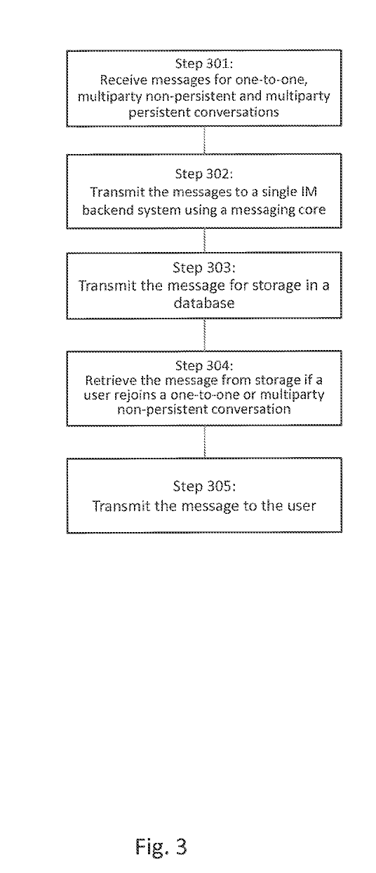

An exemplary implementation of the above-described functionality is described further with reference to FIG. 3.

FIG. 3 shows a flow diagram for receiving, transmitting, storing and retrieving messages for one-to-one, multiparty non-persistent and multiparty persistent conversations using a single IM backend system according to at least one embodiment of the invention. In this example, the IM backend system itself does not include functionality to host all three types of conversations.

At step 301, messaging core 131 receives a first message sent in connection with a one-to-one conversation, a second message sent in connection with a multi-party non-persistent conversation and a third message sent in connection with a multi-party persistent conversation.

At step 302, messaging core 131 transmits the first message to a counterparty associated with the one-to-one conversation, the second message to two or more parties associated with the multi-party non-persistent conversation, and the third message to two or more parties associated with the multi-party persistent conversation using a single IM backend system or to a single IM backend system.

At step 303, after either the single IM backend system, or messaging core 131, sends the messages to IM service application platform 135, IM service application platform 135 transmits the message to data and messaging archives 150 for storage.

At step 304, if a user attempts to rejoin a one-to-one or multiparty non-persistent conversation, messaging core 131, using IM service application platform 135, rather than the IM backend system, will retrieve the conversation history.

At step 305, messaging core 131 transmits the conversation history in a user interface file to the client device 110.

2. Connectivity to Back End Systems

Using messaging core 131, IM server 130 is capable of connecting to multiple IM backend systems, such as second IM backend system 134 and first IM backend system 133, allowing a user to communicate with other parties via conversations hosted on different IM backend systems using a single client-side application (e.g., container 111).

However, even though a conversation is hosted by one IM backend system, situations may arise where it may be necessary for IM server 130 to transfer a conversation from one IM backend system to another. For example, system administrators may decide to perform maintenance on one IM backend system, requiring a temporary disconnection from IM server 130. Another example may be that one IM backend system provides rich text functionality that is not offered by another IM backend system. A third example may be that a user is attempting to join a multiple non-persistent conversation hosted by a first IM backend system without having a IM backend system user identifier to the first IM backend system. In this example, if possible, transferring the conversation to a second IM backend system may allow all the users to join the conversation.

By connecting to multiple IM backend systems, and by providing this connectivity capability in IM server 130, IM server 130 can offer the user a seamless IM experience by transferring a conversation to a different IM backend system without the user even knowing the conversation was transferred.

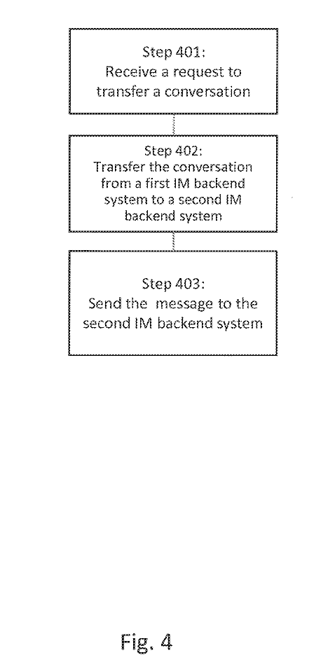

An exemplary implementation of a conversation transfer is described with reference to FIG. 4.

FIG. 4 shows a flow diagram for a method of transferring a conversation hosted by a first IM backend system to a second IM backend system according to at least one embodiment of the invention.

At step 401, either messaging core 131 or meta service 137 receives a request to transfer a conversation hosted on a first IM backend system to a second IM backend system. The request may be explicit (e.g. a system administrator decides to perform maintenance on the first IM backend system, and thereby requests a transfer) or implicit (e.g. a party having access to a second IM backend system and not the first IM backend system requests to join the conversation hosted on the first IM backend system).

At step 402, either messaging core 131 individually, or messaging core 131 and meta service 137, transfer the conversation.

In the exemplary embodiment, there may be different processes for transferring a conversation based on the conversation type, two of which are described as follows.

If the conversation is a one-to-one or multiparty non-persistent conversation, messaging core 131 can dynamically transfer the conversation hosted by a first IM backend system to a second IM backend system, where the second IM backend system will subsequently host the conversation.

To transfer a one-to-one or multiparty non-persistent conversation to a second IM backend system, messaging core 131 may create a new conversation, as described above. In one embodiment, the new conversation can only be created if messaging core 131 identifies that the second IM backend system is a compliant IM backend system for processing and transmitting the instant message. In one embodiment, to identify a compliant IM backend system, messaging core 131 determines that all of the user meta identifiers (e.g. first and second user meta identifiers) for all parties each correspond with respective IM backend system user identifiers (e.g. first and second IM backend system user identifiers) associated with the same IM backend system. In other embodiments, transfer of the conversation to the second IM backend system may occur in other manners (i.e., without creating a new conversation as described above).

If the conversation is a multiparty persistent conversation, messaging core 131, along with meta service 137 can transfer the conversation hosted by a first IM backend system to a second IM backend system, where the second IM backend system will subsequently host the conversation.

Messaging core 131 and meta service 137 can identify and transfer a multiparty persistent conversation to a second IM backend system if the multiparty persistent conversation is capable of being created and hosted on the second IM backend system.

To transfer a conversation (i.e. a first conversation instance), a second conversation instance may be created in data and messaging archive database 150 using meta service 137. In one embodiment, the second conversation instance is associated with all of the same information as the first conversation instance, including the same conversation meta identifier, except that a new IM backend system identifier associated with the second IM backend system replaces the old IM backend system identifier associated with the first IM backend system. As discussed throughout, the conversation meta identifier is used to retrieve message history associated with the conversation. In addition, the status indicator for the second conversation instance may be set to active and the status indicator for the first conversation instance may be set to inactive. In other embodiments, transferring a conversation may occur in other manners different from that described above.

After the second conversation instance is created, if messaging core 131 attempts to exchange messages with (e.g., send messages to or receive messages from) the first IM backend system associated with the first conversation instance, messaging core 131 will receive an error message.

After retrying to exchange messages for a predetermined number of retries, messaging core 131 can retrieve the information associated with the second conversation instance, including the second IM backend system identifier from meta service 137. Meta service 137 uses the status indicator associated with the second conversation instance to determine that the new conversation information, including the second IM backend system identifier, needs to be sent to messaging core 131.

Alternatively, meta service 137 can push the second conversation instance with all associated information to messaging core 131, without the messaging core 131 needing to make a request for the second conversation instance.

At step 403, messaging core 131 will then subsequently update its session information in its local memory and exchange messages (e.g. send the message) using the second IM backend system for the corresponding conversation.

3. Separation of Messaging Core and Container

In the system described with reference to FIG. 1, messaging core 131 performs the message processing and container 111 performs the rendering through the user interface.

In conventional systems, messaging core 131 and container 111 may be implemented in a single application. However, the problem with conventional systems is that some changes made to the IM system may require changes to the front-end client application residing on the client device. For example, if a new IM backend system is added to the IM service, conventional systems require modifications to the client application and a reinstallation or update of the client application on the client device 110. The required reinstallation of the client application on all of the client devices connected to the IM system can be a time consuming and cost intensive process.

To address this issue, the client application is separated into two separate and distinct components, the messaging core 131 and container 111, in connection with system 100. The messaging core 131 performs the message processing while container 111 performs rendering through user interface 112. Using this configuration, if the messaging core 131 is implemented remote from client device 110, such as in IM server 130, the user would not have to even know that a change was made to the IM system, let alone reinstallation or update of the client application. In addition, even if messaging core 131 is installed on a client device, by separating the messaging core 131 from container 111, container 111 can be incorporated or embedded into a different application without any need to coordinate future updates with the different application because all updates will be made to messaging core 131 instead.

For example, system 100 includes two IM backend systems, first IM backend system 133 and second IM backend system 134. One of the backend systems, e.g. first IM backend system 133, may start to incur problems that only become apparent after implementation. To solve the problem, a new set of code needs to be installed in applications communicating with first IM backend system 133. In a conventional system, the client application needs to be modified and reinstalled on the client device. In system 100, only the messaging core 131 needs to be modified. If the messaging core 131 is positioned separate from container 111, no additional reinstallation is necessary for container 111 and any possibility of a service interruption or change in user interface as experienced by the user can be avoided.

In conventional systems, where there is no separation between messaging core 131 and container 111, a client IM application can communicate with multiple IM backend systems. In use, the client application receives a message along with a request to communicate with a server implementing one of the IM backend systems. The client application then converts the message into an IM backend system compliant message using a specific communication protocol to communicate the plain text message.

In connection with embodiments described herein, messaging core 131 and container 111 are separated, thus an extra transmission of information is required. This extra transmission is implemented as an abstraction layer having a pre-specified application protocol that is used to communicate between the two software components. Alternatively, the application protocol is a communication protocol used to communicate information between two separate and distinct devices using the Open Systems Interconnection model (OSI) application layer. The application layer is an abstraction layer reserved for communications protocols and methods designed for process-to-process communications across an internet protocol computer network. Examples of a protocol may include hyper text transfer protocol (HTTP) or CometD.

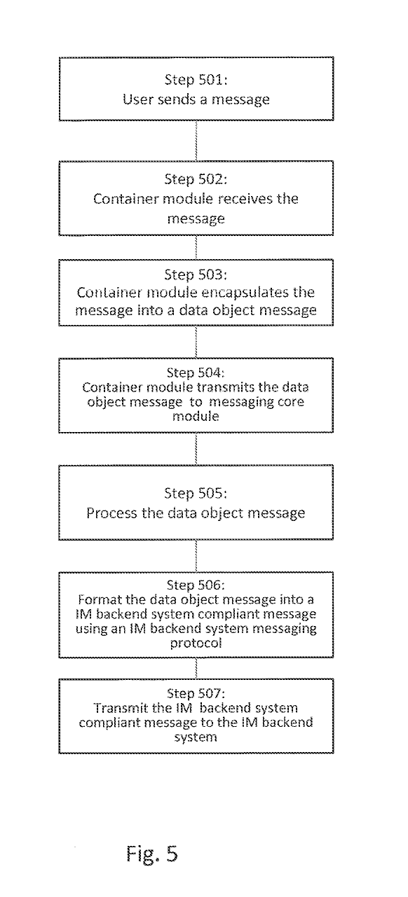

Implementation of the container 111 (i.e. container software module) and messaging core 131 (i.e. messaging core software module) is described further with reference to FIG. 5.

FIG. 5 shows a flow diagram for a method of transmitting a message using a container and a messaging core according to at least one embodiment of the invention.

Initially, at step 501, a user employing client device 110 sends a message to a party or conversation.

Next, at step 502, container 111 receives the message.

At step 503, container 111 encapsulates the message using an application protocol, such as HTTP/HTTPS and CometD, along with additional metadata such as information regarding the user as the sender of the message, the counterparty as the receiver of the message, and a timestamp.

Encapsulation involves converting message into a predefined data object, which can be accomplished in a variety of different ways within the scope of the present invention. To perform encapsulation, in accordance with one exemplary embodiment, container 111 reads various pieces of data from the message and converts the pieces of data into a data object message using, for example, JSON notation. The data object message includes a message payload containing the substantive data of the data object message. The data object message also includes meta data that describes the data object message. As an example of a data message object, a message from Alice to Bob containing a payload of “Bob, please give me a call.” may be converted into a data object message: {“From”:“Alice”, “To”:“Bob”, “Payload”:“Bob, please give me a call.”}

After encapsulation, at step 504, container 111 transmits the data object message (i.e. encapsulated message) to messaging core 131 using, e.g., CometD. The data object message may include additional metadata and protocol specific data. For example, the data object message may include a target endpoint identifying the party that eventually receives the message.

The data object message may be associated with a session hosted on messaging core 131. The data object message may also include session information. The session information describes a particular communications channel (i.e. session) from container 111 to messaging core 131 so that both container 111 and messaging core 131 can exchange data. The session may be associated with a session identifier identifying the session between messaging core 131 and container 111. The data object message may include, at the HTML application layer, a cookie previously received from messaging core 131 for session authentication. The cookie may include the session identifier.

The data object message transmitted from container 111 to messaging core 131 may have different representations. Representations include a plain text representation or a rich text representation. To identify the representation, the data object message includes a field called content with sub-fields called plaintext and rich text. Messaging core 131 processes the data object message based on the selected field and sub-field.

To transmit the data object message to messaging core 131, container 111 uses, e.g., HTTP/HTTPS and CometD, communications protocols to transmit the encapsulated data object message.

At step 505, after messaging core 131 receives the data object message from container 111, messaging core 131 processes the metadata of the encapsulated data object message and determines an appropriate IM backend system for the encapsulated data object message.

To process the metadata, messaging core 131 reads the data object message and extracts the metadata. The metadata may include the sender of the message, the recipient of the message and a representation (e.g. plaintext, rich text, etc). The sender of the message may be identified using the user meta identifier of the user of client device 110. The recipient of the message may be identifier using the user meta identifier of the recipient.

Next, messaging core 131 will either create a new conversation, as described above in “Creating a Conversation” or join a new conversation, as described above in “Joining a Conversation,” if the user has not created or joined a conversation.

At step 506, messaging core 131 then parses the data object message and converts (i.e. formats) the data object message into a message that is compliant with an IM backend system based on, or using, a messaging protocol of the IM backend system. For example, if an IM backend system is XCP, messaging core 131 converts the message as required for compliance with XMPP.

The following is an example of an XMPP message:

<message

to=‘Bob@XCP’
from=‘Alice@XCP’
type=‘chat’
xml:lang=‘en’>
<body>Bob, please give me a call.</body>

</message>

After messaging core 131 converts the payload into an IM backend system compliant message, at step 507, messaging core 131 transmits the IM backend system compliant message to the corresponding IM backend system determined by the messaging core 131 using an appropriate communications protocol.

II. Use of Plugins to Extend Instant Messaging Functionality

Plugins are pieces of software which extend existing code and, when executed on client device 110, can be applied to extend an instant messaging application, and more specifically a user interface, in a range of contexts to control different aspects of the interface, such as the way that user interface, message content and the user interaction is displayed to a user of client device 110. As container 111 submits and receives messages, plugins can provide additional extensions to alter how the container 111 interacts with messages and how the user interface 112 displays the messages. Plugins can be applied in a variety of ways dependent on context (e.g. content filtering to restrict display or transmission of certain text patterns for a particular user or during a particular conversation).

Also, several plugins can be applied to the same context in a hierarchical interaction.

A. Dynamic Extension

In conventional systems, any changes, modifications or updates to a user interface of an instant message application on a client device are initiated by either a developer or user at a time other than when a user is using the instant messaging application. This results in a static user interface for the user, meaning the user interface does not change while the user is using the instant messaging application. System 100 offers the capability to extend a user interface 112 for an instant messaging application on a client device dynamically, meaning, while the user is using the IM service, by dynamically delivering plugins to extend a user interface even while the user is using the instant messaging application.

More specifically, dynamic delivery of a custom user interface is the ability of IM server 130 to deliver plugins to a client device 110 for an IM session in the event of an application context change (e.g., joining a conversation or logging into the instant messaging service), for a duration of the IM session (e.g. until the IM session is terminated) or until another application context change (e.g. leaving a conversation or terminating access to a conversation). The IM session is the period of time when a user is accessing an IM service using the instant messaging application. The IM session begins when a user initially requests access to the IM service and ends when the user disconnects from the IM service. Any subsequent connection to the IM service represents a new and different IM session. The automatic deployment of plugins to enhance allows several different extensions to be applied to the same user session but only experienced when it is appropriate to the context. Dynamic deployment also allows many plugins to be created and managed centrally without requiring the deployment of all plugins to all users or the user to manually download the required files to achieve the extension.

This also means that updates to plugin versions can be managed and updated on the system without any noticeable change to the end user, as the new plugin is automatically downloaded when it is applied to that context.

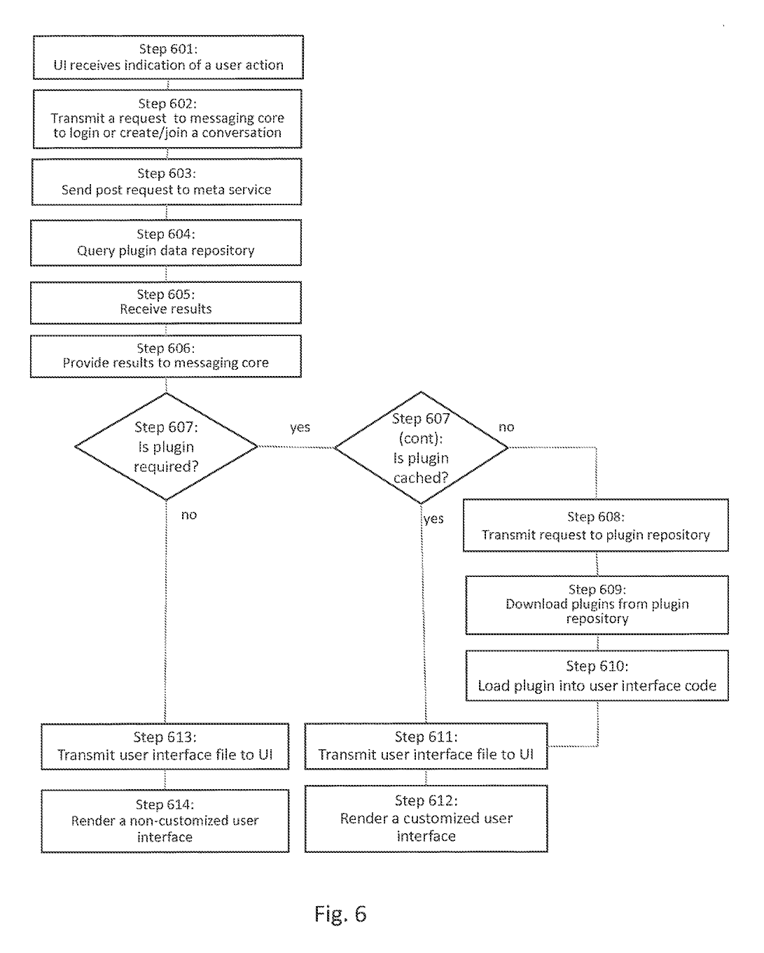

In FIG. 6, there is shown a flow diagram for a method of dynamically delivering an instant messaging user interface extension to client device 110 according to at least one embodiment of the invention.

Initially, client device 110 displays a user interface 112 to a user. User interface 112 includes a user-selectable icon that, when selected by a user, causes client device 110 to send a request to login to the instant messaging service hosted by IM server 130 or send a request to join a conversation. In different embodiments, the client device may be manned by a person or by a machine.

At step 601, user interface 112 receives indication of a user action performed by a user. User action may be a request to login, a request to create or join a conversation, a request to download a plugin, etc.

At step 602, user interface 112 transmits a request to messaging core 131 to either login to the instant messaging service hosted by IM server 130 or create/join a conversation. The request to the messaging core 131 may also be a request to download a plugin. The request may include an identifier, such as a user meta identifier of the user, a conversation meta identifier, or a user meta identifier of one or more parties. The identifier may comprise data describing an end user such as an identity of the end user, the location of the end user, business unit, company name, etc. The identifier may comprise data describing the device, such as device capabilities. For example, some devices may only be able to render simple plain text messages or rich text messages. Some devices may be a low fidelity low bandwidth device, such as when a device has limited internet bandwidth. In these scenarios, plugin may be used to limit display of rich text, images, etc.

If the request is a request to create a one-to-one conversation, the request includes at least a user meta identifier and a user meta identifier (i.e. counterparty identifier) of a counterparty.

If the request is to create a non-persistent multiparty conversation, the request includes at least a user meta identifier and two or more user meta identifiers of two or more parties.

If the request is a request to join a non-persistent multiparty conversation or a persistent multiparty conversation, the request includes a conversation identifier. The request may also include an address (e.g. URL) associated with the message transmission channel.

User meta identifier is a string of characters and/or numbers that identifies the user of client device 110 or another party that uses the IM service.

Client device 110 relies on JavaScript and CometD to interact between user interface 112 and messaging core 131 of IM server 130 in order to send and receive messages. HTML, CSS and JavaScript are used to display the content in the user interface 112.

At step 603, after messaging core 131 receives the request from user interface 112, messaging core 131 sends a post request to meta service 137. The post request may specify whether the user action was login or conversation based. If the user action is login based, the post will identify user login information. If the user action is conversation based, the post request may identify the conversation or type of conversation that was requested. The post request may also include one or more user meta identifiers, such the user and possibly any additional parties, and/or a conversation meta identifier. The conversation is identified using a conversation meta identifier. The conversation meta identifier is a unique identifier of the conversation used by the IM service. The conversation meta identifier is associated with one or more IM backend system conversation identifiers. The conversation meta identifier may also identify the type of conversation (e.g. a one-to-one conversation, multiparty non-persistent conversation, or multiparty persistent conversation).

The post request may also include an IM backend system identifier, conversation type identifier, persistent multiparty conversation identifier, persistent multiparty conversation membership identifier, a non-persistent multiparty conversation identifier, a non-persistent multiparty conversation membership identifier and/or a counterparty identifier.

IM backend system identifier is a string of characters and/or numbers that identifies the IM system accessed by the user of client device 110. Examples of IM systems include first IM backend system 133 and second IM backend system 134.

Conversation type identifier is a string of characters and/or numbers that identifies the type of conversation that the user is requesting to join. Examples of conversation types include one-to-one conversation, non-persistent multiparty conversation, and persistent multiparty conversation.

Persistent multiparty conversation identifier is a string of characters and/or numbers that identifies a unique persistent multiparty conversation that the user is attempting to join or create.

Persistent multiparty conversation membership identifier is a string of characters and/or numbers that identifies a unique persistent multiparty conversation membership of a persistent multiparty conversation.

Non-persistent multiparty conversation identifier is a string of characters and/or numbers that identifies a unique non-persistent multiparty conversation that the user is attempting to join.

Non-persistent multiparty conversation membership identifier is a string of characters and/or numbers that identifies a unique persistent multiparty conversation membership of a persistent multiparty conversation.

Counterparty identifier is a string of characters and/or numbers that identifies another member of a conversation other than the user.

At step 604, after meta service 137 receives a post from messaging core 1313, meta service 137 queries data and messaging archive database 150 to identify whether there is a plugin mapping to the user logging in to the instant messaging service or joining a conversation. The query may include information in the post from messaging core 131, including one or more of: user login information, one or more user meta identifiers of the user or parties of the IM service, a conversation meta identifier, conversation type identifier, IM backend system identifier, persistent multiparty conversation identifier, persistent multiparty conversation membership identifier, non-persistent multiparty conversation identifier, non-persistent multiparty conversation membership identifier and a counterparty identifier.

At step 605, meta service 137 receives results from data and messaging archive database 150. The results of the database query identify if one or more plugins are required for download on client device 110. If any plugins are required, the query result will include at least one of: the plugin name and the plugin uniform resource identifier (URI), for each required plugin.

At step 606, after meta service 137 receives results from data and messaging archive database 150, meta service 137 provides a response to the API call from messaging core 131. The response to the API call includes either (i) an indication that no plugin is required or (ii) the plugin name and/or the plugin URI, for each plugin.

At step 607, if the response to the API call indicates that a plugin is required; messaging core 131 determines whether the plugin is cached with core application JavaScript user interface code on client device 110. To determine whether the plugin is cached, messaging core 131 checks its local cache for any data indicating that the plugin, or the plugin code, was sent to client device 110.

At step 608, for each plugin identified in the response to the API call, if the response to the API call indicates that a plugin is required, and messaging core 131 determines the plugin is not cached, messaging core 131 transmits a file input/output (I/O) call request to download the plugin from the plugin repository 160 using search service 136. The request includes the plugin URI, for each plugin. An example of a file I/O call is file.get(‘/theplugindir/1.zip’). This file I/O call is a java file system call to a retrieve a file if the folder path in plugin repository 160 is predetermined, and identified by a configuration parameter, and the name is determined by the plugin number being requested.

At step 609, messaging core 131 downloads a zip file containing the one or more plugins from the plugin repository 160 using search service 136.

At step 610, after downloading the zip file, messaging core 131 reads one or more plugin files contained in the zip file and loads the plugin files into core application JavaScript user interface code. It will be appreciated that other embodiments may use different file types to transmit the plugins, including alternative compressed files or possibly uncompressed files.

At step 611, messaging core 131 provides the core application JavaScript user interface code as a user interface file to user interface 112.

At step 612, after receiving the user interface file from messaging core 131 or, alternatively, after messaging core 131 determines that the one or more plugins are cached with the core application JavaScript user interface code, at step 607, user interface 112 renders an extended user interface using the core application JavaScript user interface code or the previously cached core application JavaScript user interface code. The extended interface may include, e.g., changes to any banners displayed on the user interface 112, any changes to font type of any displayed text, and location of any windows, such as the chat window displaying all text messages exchanged using the IM service or the message interface window for receiving messages from the user of client device 110. In addition, the plugin(s) can also extend any messages that are sent or received using user interface 112 (e.g. message content filtering or displaying video in the user interface 112).

At step 613, if the response to the API call at step 606 indicates that a plugin is not required, messaging core 131 transmits the core application JavaScript user interface code as a user interface file without any additional customizations to user interface 112.

At step 614, after receiving the user interface file without any additional customizations from messaging core 131, user interface 112 renders a non-extended display interface.

In some embodiments, an administrator may manage automatic deployment of plug-ins. For example, an administrator may programmatically instruct that all users, or users having a particular personal or system-related characteristic, need to load a plug in. In this instance, a message may be sent to the client device instructing the client device to download the plug in.

B. Granular Extension

Plugins may be applied to a user interface in a number of different contexts (e.g., situations that may require different extensions, such as customizations or enhancements, to be applied to the instant messaging application), including a system-wide context, a user-wide context, a conversation type context, a persistent multiparty conversation context, a persistent multiparty membership context, and counterparty context.

A system-wide context means that the plugin is applied to a user interface for a user with a user account on a particular IM backend system and can interact with all conversations and messages involving all client devices associated with the particular IM backend system

One example of a system-wide context plugin is a plugin which puts a banner at the top of the application to alert all users of their company's upcoming financial statement announcement. The plugin can be applied at the start of the week and removed after the announcement. To retrieve a system-wide context plugin, a request for the plugin is required to include an IM backend system identifier (i.e., to identify the relevant system).

A user-wide context means that the plugin is applied to a user interface and conversations and messages sent or received by a specific user of client device 110. A user without the plugin applied will not see any plugin extensions or changes in functionality in user interface 112. One example of a user-wide context plugin is a plugin which makes all new messages appear in the user interface 112 with red and 18 pt font. To retrieve a user-wide context plugin, a request for the plugin is required to include a user meta identifier.

A conversation type context means that the plugin is applied to a user interface and messages sent or received for a user of conversations of a given type, either one-to-one, non-persistent multiparty or persistent multiparty. The plugin extension would be applied to all conversations of that type within the user interface 112. One example of a conversation type context plugin is a plugin which makes every one-to-one conversation in the instant messaging service display the last emails that were sent by the user to the counterparty. To retrieve a conversation type context plugin, a request for the plugin is required to include at least the conversation type identifier, and in some instances, the IM system identifier.

A persistent multiparty conversation context means that the plugin is applied to a user interface and messages sent or received for a user of a single or particular persistent multiparty conversation. One example of a persistent multiparty conversation context plugin is a plugin which displays a specific dashboard in the user interface 112 for the specific persistent multiparty conversation. To retrieve persistent multiparty conversation context plugin a request for the plugin is required to include a conversation meta identifier.

A persistent multiparty conversation membership context means that the plugin is applied to messages sent or received by a specific user for a specific persistent multiparty conversation based on a user membership role in the specific persistent multiparty conversation. Based on a party's membership role in the conversation (e.g. participant, owner, etc), the party will receive an associated plugin. Users participating in the conversation that do not have the corresponding membership role will not have the plugin loaded to their user interface. To retrieve persistent multiparty conversation membership context plugin, a request for the plugin is required to include a persistent multiparty conversation membership identifier associated with the persistent multiparty conversation.

One example of a persistent multiparty conversation membership context is when a user with a given membership role in a particular persistent, multiparty chat room, joins that chat room, he sees a dashboard rendered by the plugin showing the topics being discussed in the chat room. In contrast, another user with a different membership role will only see the standard conversation view without the dashboard in the user's display. Another example of a dashboard customization involves a helpdesk channel. One user, the help desk operator, may see a small window at the top of the channel in the user interface with the current waiting queue displayed. Another user, a help desk supervisor, may have a different view showing both the queue and the time to respond from the help desk operators. Other examples of a plugin providing a different view to a chat room to different users are within the scope of the present invention.

C. Counterparty Extensions

A counterparty context means that the plugin is applied to a user based on the counterparty participant to a conversation. Any participant who joins a conversation with another counterparty will receive the plugin extension in the participant's user interface. The counterparty context plugin functionality allows customisation to be based on the context of the counterparty exchanging messages with the user.

One example of a counterparty context plugin is a plugin that shows a picture of the user who is associated with the counterparty identifier. Any counterparty user who joins a conversation with that user will see the user's picture in their user interface. The user themselves will not load the plugin or see the picture.

Another example of a counterparty context plugin is a plugin that displays to the user, when a user communicates with a colleague, a rating score of the colleague's previous responses or branding of the colleague's department, disclaimer, identifier or customised greeting.

In an instant messaging context, as real-time messaging is about dialogue, it is often desirable to receive additional information about the other participant at the point of conversation. While the core information about the participant will be delivered as part of the full application, counterparty customization allows for the implementation of additional non-standard visual and functional behaviour for participants.

To retrieve a counterparty context plugin, a request for the plugin is required to include a counterparty identifier.

III. Message Processing to Implement Extensions

A. Processing an Outgoing Message

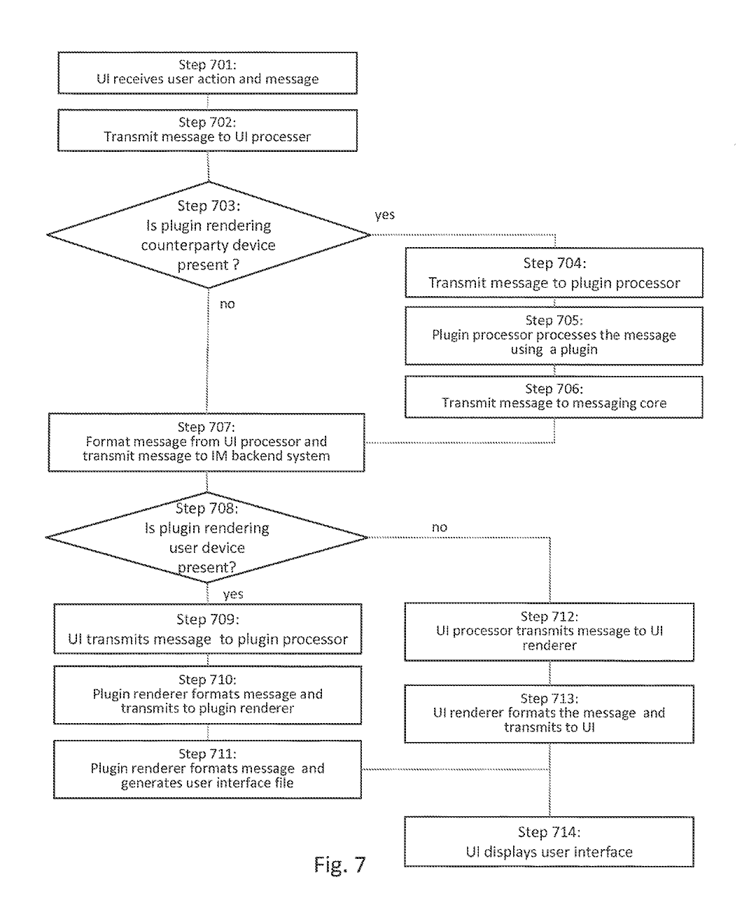

In FIG. 7, there is shown a flow diagram for a method of processing an outgoing message using plugins in an instant messaging context according to at least one embodiment of the invention.

Generally, system 100 performs two actions when sending a message: the transmission of the message to the corresponding IM backend system (e.g. second IM backend system 134) and the rendering of that message in the local user interface. This provides a faster response to the user compared to waiting to receive the sent message from the corresponding IM backend system or requesting message history response from the server.

At step 701, user interface 112 receives a user action from a user indicating that the user-selectable icon (e.g. a “send” button) was selected and a message.

At step 702, after user interface 112 receives the user action from the user, user interface 112 transmits a message from the user to UI processor 113.

At step 703, after receiving the message from user interface 112, UI processor 113 determines whether a plugin for rendering a message on a counterparty or another party user interface is present. To determine if a plugin is present, UI processor 113 could store a list of plugins, and then check the list to determine if there are any plugins for rendering a message on a counterparty or another party's user interface.

At step 704, if a plugin for rendering a message on a counterparty or participant user interface is present as determined at step 703, UI processor 113 transmits the message to plugin processor 114.

At step 705, after receiving the message from UI processor 113, plugin processor 114 processes the message using one or more plugins. Plugin processing may include modifying a message in a message in a variety of different ways. For example, the plugin could modify the message by removing the word “account” or bold the word “urgent” in a message. The plugin could trigger another function, e.g., based on a particular words included in the message. The plugin could prevent other plugins or base code from being applied to the message or, conversely, allow other plugins and/or base code to further process the message.

Next, plugin processor 114 transmits a plugin response to UI processor 113. The plugin response includes the message as formatted based on any plugins that were applied to the message.

At step 706, after receiving the plugin response from plugin processor 114 if a plugin was present in container 111, or after receiving a message from user interface 112 if a plugin was not present in container 111, UI processor 113 invokes a CometD publish command to transmit the message (either original or formatted) and message metadata to messaging core 131. Message metadata may include information regarding the user that sent the message, and a party or conversation that is receiving the message.

At step 707, after receiving the message and message metadata from UI processor 113, messaging core 131 formats the message from UI processor 113 into a compliant IM backend system message according to a communication protocol (e.g. XMPP) associated with the IM backend system (e.g. second IM backend system 134). Messaging core 131 then parses the message to extract the payload(s) (i.e., message data) and converts the message with the message payload into a compliant IM backend system message using the appropriate communication protocol used by the IM backend system.

Next, messaging core 131 transmits the compliant IM backend system message to the IM backend system (e.g. second IM backend system 134).

At step 708, after the compliant IM backend system message is sent to the IM backend system, UI processor 113 determines if a plugin related to user rendering on user interface 112 is present on container 111. To determine if a plugin is present, UI processor 113 could store a list of plugins, and then check the list to determine if there are any plugins for rendering a message on a user interface 112 of client device 110.

If a plugin related to rendering a message on user interface 112 is present, UI processor 113 transmits the message to plugin processor 114, at step 709.

At step 710, after receiving the message from UI processor 113, plugin processor 114 processes the message according to an applicable plugin to provide the required enhanced rendering on the user interface 112 of the user before transmitting the message to plugin renderer 116. The plugin(s) may modify message content or call any code function contained within the plugin to perform actions, similar to any other customization and enhancements discussed throughout. The actual functions performed are dependent on the code written in the plugin.

At step 711, after receiving the message from plugin processor 114, plugin renderer 116 formats the message using, e.g., JavaScript, CSS and HTML, into an HTML stanza (i.e., a completely parse-able portion of HTML code), to generate a user interface file (e.g. HTML page) for display on user interface 112 and transmits the user interface file, along with other display components to user interface 112.

At step 712, if UI processor 113 determines that a plugin related to user rendering on client device 112 is not present in container 111 as described at step 708, UI processor 113 transmits the message to UI renderer 115.

At step 713, after receiving the message from UI processor 113, UI renderer 115 formats the message using JavaScript, CSS and HTML, into an HTML stanza to generate a user interface file (e.g. HTML page) and transmits the user interface file, along with other display components, for display on user interface 112.

At step 714, user interface 112 displays the user interface including the formatted message to the user.

B. Processing an Incoming Message

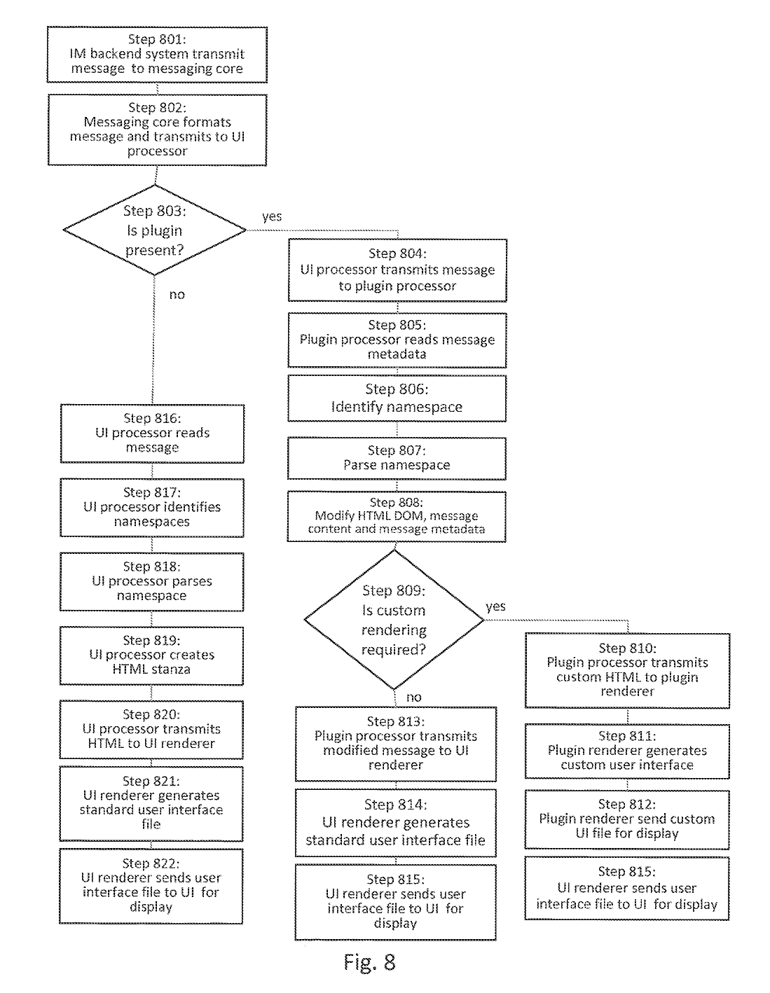

In FIG. 8, there is shown a flow diagram for a method of processing an incoming message using plugins in an instant messaging context according to at least one embodiment of the invention.

Initially, an IM backend system (e.g. second IM backend system 134) receives a message originating from client device 110 with the intention of displaying the message on a user interface of client device 118.

At step 801, IM backend system (e.g. second IM backend system 134) transmits the message to messaging core 131 using a communications protocol associated with the IM backend system (e.g. XMPP).

At step 802, after receiving the message from IM backend system (e.g. second IM backend system 134), messaging core 131 formats the message. Formatting is required because when a message is received from an IM backend server, it arrives in the communications protocol format for that IM backend system.

To format the message, messaging core 131 reads the message to identify the IM backend system conversation identifier (e.g. one-to-one, multiparty persistent, multiparty non-persistent) associated with the message. Next, messaging core 131 checks its memory for the session identifier associated with the IM backend system conversation identifier and identifies a conversation meta identifier associated with the IM backend system conversation identifier.

Then, messaging core 131 processes the message to identify the IM backend system user identifier of the recipient associated with the message. Next, messaging core 131 checks its memory for the session identifier associated with the IM backend system user identifier and identifies a user meta identifier associated with the IM backend system user identifier.

Next, messaging core 131 extracts the message payload (i.e. the message data, not the information that describes the message) and inserts the message payload, along with the conversation meta identifier and the user meta identifier into a new formatted message.

Next, messaging core 131 transmits the new formatted message to UI processor 113 on client device 118.

At step 803, after receiving the formatted message from messaging core 131, UI processor 113 determines whether a plugin is present on container 111. To determine if a plugin is present, UI processor 113 could store a list of plugins, and then check the list to determine if there are any plugins.

At step 804, if a plugin is present, UI processor 113 transmits the message to plugin processor 114.

For the following steps, steps 805-808, after receiving the message from UI processor 113, plugin processor 114 processes the message based on one or more plugins. This processing function is where extensions of client behavior is controlled. The processing function will take the message and execute the specific plugin code required to perform the required action.

At step 805, plugin processor 114 reads message metadata. “Read” means extract or parse certain fields in the message. Message metadata refers to fields that are not in the message payload. Examples of message metadata include: the sender (e.g. a “from” field), the recipient (e.g. a “to” field), a timestamp indicating when the message was sent (e.g. a “timestamp” field), and a conversation identifier identifying a conversation associated with the message (e.g. a “conversation identifier” field).

At step 806, after plugin processor 114 reads message metadata, plugin processor 114 identifies one or more payload namespaces. For example, plugin processor 114 may identify the presence of one or elements in a predetermined namespace such as <x> . . . </x>.

At step 807, after plugin processor 114 identifies one or more payload namespaces, plugin processor 114 parses the payload namespace and identifies at least a portion of the message payload relevant to one or more plugins.

At step 808, after plugin processor 114 parses the payload namespace, plugin processor 114 generates a custom HTML stanza based on a number of modifications. In one modification example, plugin processor 114 modifies the HTML DOM in order to change the content of HTML elements used in the user interface file displayed on user interface 112 that are related to the received message and are based on one or more plugins. An example of an HTML DOM modification may include adding or removing component features such as removing a text box for sending message in the user interface for a specific conversation if a message from the conversation owner places a restriction on exchanging messages in the conversation for a particular party. Plugin processor 114 also modifies the message content based on one or more plugins. An example may include redacting certain content from the message, such as bank account numbers, if a message includes a bank account number. Lastly, plugin processor 114 modifies the message metadata based on one or more plugins. An example may include redacting the recipient name in the message meta data to provide anonymity to all parties posting messages to a specific conversation.

At step 809, after plugin processor 114 performs the modifications in step 808, plugin processor 114 determines if plugin extended user interface rendering by plugin renderer 116 is required. To make this determination, plugin processor 114 may store a list of plugins related to plugin extended user interface rendering, and then check the list to determine if there are any related plugins.

At step 810, if plugin extended user interface rendering is required, plugin processor 114 transmits the custom HTML stanza to plugin renderer 116.

For the following steps, steps 811-812, after plugin renderer 116 receives the custom HTML stanza, plugin renderer 116 controls the extension of client user interface rendering. Plugin renderer 116 executes a plugin with a rendering function which will take the message packet (optionally processed by the plugin processor 114) and change how the message is visualized in user interface 112. In one example, this may be the application of a different Cascading Style Sheet (CSS) to user interface 112.

At step 811, after plugin renderer 116 receives the modified message, plugin renderer 116 processes the HTML stanza and generates a custom user interface file with the modified message based on the applicable plugin. Custom rendering includes applying CSS, adding additional message HTML DOM to change the content of HTML objects in the custom user interface file and adding additional resources (e.g. images, videos, etc.).

At step 812, after plugin renderer 116 generates the custom user interface file, plugin renderer 116 sends the custom user interface file to user interface 112 for display on client device 118.

At step 813, if plugin extended rendering is not required as determined in step 809, plugin processor 114 transmits the modified message to UI renderer 115.

At step 814, after UI renderer 115 receives the modified message, UI renderer 115 generates a user interface file including the modified message based on a standard rendering protocol. Standard rendering includes font characteristics such as: bold, underline, text font, size color, as defined by the CSS filed stored in container 111.

At step 815, after UI renderer 115 generates the standard user interface file, UI renderer 115 sends the standard user interface file to user interface 112 for display on client device 118.

For the following steps, steps 816-820, if a plugin is not present as determined in step 803, in the case of the UI processor 113, the message is processed in the standard way of the UI without additional plugin interaction.

At step 816, if a plugin is not present as determined in step 803, UI processor 113, UI processor 113 reads message metadata as described above at step 805.

At step 817, after UI processor 113 reads message metadata, UI processor 113 identifies one or more payload namespaces as described above at step 806.

At step 818, after UI processor 113 identifies one or more payload namespaces, UI processor 113 parses the payload namespace to identify at least a portion of the message relevant for formatting.

At step 819, after UI processor 113 parses the payload namespace, UI processor 113 creates a standard HTML stanza based on the message payload in the payload namespace.

At step 820, after UI processor 113 creates a standard HTML stanza, UI processor 113 transmits the HTML stanza to UI renderer 115.

At step 821, after UI renderer 115 receives the HTML stanza from UI processor 113, UI renderer 115 generates a standard user interface file with the HTML stanza based on the standard rendering protocol described above at step 814.

At step 822, UI renderer 115 sends the standard user interface file to user interface 112 for display on client device 118.

C. Examples of Extended Deployment

1. Survey Plugin Example

While using the instant messaging service, a user may want to ask a question to a multiparty conversation and allow individual participants to respond with one of a set of responses. Using the survey plugin functionality, a user interface 112 may include a survey banner showing the results of a survey. In the survey banner, a user has asked “Interested in Apple Research?” and all other participants of the conversation can give their optional responses “Yes” or “No,” by clicking user-selectable icons on their respective user interfaces. When a participant clicks one of the buttons to respond to the survey, a message is sent to all participants in the conversation. After the message is processed by the plugins, each user interface for each participant will update a pie chart icon on all user interface displays with the updated survey results.

2. Video Plugin Example

While using the instant messaging service, a user may want to be able to provide a participant in a conversation with a video hosted on a central video hosting solution and displayed on the user interface 112 in an instant messaging window (not shown). The video plugin functionality is desirable for some conversations but may not be suitable for all conversations. By utilizing a plugin, specifically the video plugin, the video messaging functionality would be associated with conversations where the functionality would be desired.

To provide the video to the participant using the instant messaging service, the user initially sends a message containing a video plugin command and a video identifier, separated by a colon (e.g. video:19458″).

The plugin loaded on the conversation by all participants will intercept the incoming message and recognize that “video” needs to trigger custom rendering and parse the video ID from the message.

The plugin renderer 116 on container 111 replaces the video ID with an HTML5<video> tag linked to the video 19458. The modified message will then be sent to all recipients on the room.

All recipients of this message will receive the message with the video tag <video><source src=“http://video.barclays.com/19458” type=“video/mp4”></video> embedded into the message.

When this HTML message is viewed in the UI, the video will be rendered in line in the User Interface.

3. Natural Language Inference Example

Natural language inference involves actions by the client device 110 or IM server 130 in response to inferences identified in an instant message by a plugin. The natural language inference plugin contains JavaScript source code which will interact with messages as they are sent and received by user interface 112.

The actions may be executed as a result of detecting one or more triggers, which can be made up of regular expressions and additional logic. The plugin parses the message content and invokes additional communication functionality (e.g. text, telephony, video conferencing, email, file transfer, screen-sharing, etc) if that trigger is activated. Both sent and received messages can be monitored for triggers.

An example of the natural language inference plugin may include recognizing that a user might want to make a telephone call based on a sent or received message and displaying telephony functionality (e.g. a selectable phone dial pad icon) with the other party's telephone number already entered in the user interface 112 if a user receives a message that recites “Are you free for a quick call?”

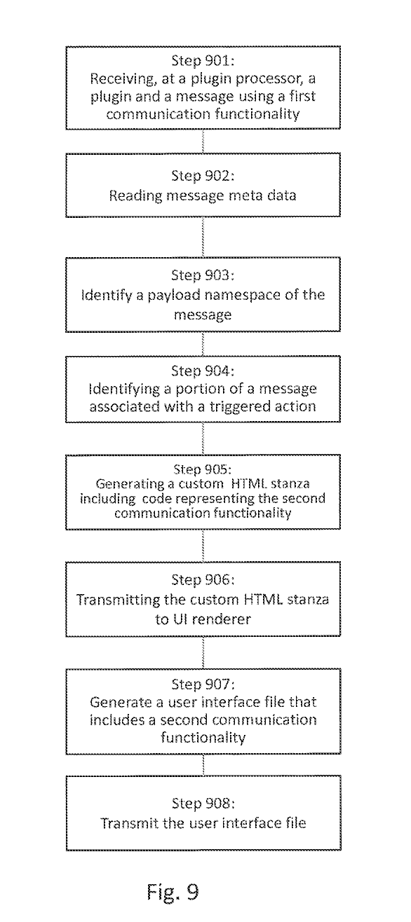

With reference to FIG. 9, the following description provides a step-by-step explanation of how container 111 processes the above message using a natural language inference plugin.

In FIG. 9, there is shown a flow diagram for generating a user interface with a new communication functionality using a plugin according to at least one embodiment of the invention.

After receiving a natural language inference plugin and after plugin processor 114 receives the above message from UI processor 113, similar to step 804 in FIG. 8, at step 901, plugin processor 114 reads message metadata from the message, similar to step 805, at step 902. In this instance, reading that the message is from a particular sender may cause container 111 to make a search request to IM server 130 to retrieve a telephone number for the particular sender from active directory 140 or data and messaging archives database 150 for display in the dial pad icon in user interface 112.

Similar to step 806, at step 903, plugin processor 114 identifies a payload namespace. In this example, there may be a payload namespace called <msgpayload> . . . </msgpayload> and this namespace includes the message, “Are you free for a quick call?”

Similar to step 807, at step 904, plugin processor 114 parses the payload namespace.

Similar to step 808, at step 905, plugin processor 114 may identify a portion of the message payload or message meta data relevant to a natural language plugin and associated with a triggered action. In one example, the triggered action may involve adding a new communication functionality to a user interface. If plugin processor 114 determines that the receiving party may need to communicate with the sending party using a new communication functionality based on a plugin and/or the received message, plugin processor 114 may generates a custom HTML stanza that includes code representing the new communication functionality based on a number of possible modifications. For example, plugin processor 114 may modify the HTML DOM to change some of the content of HTML elements that may be displayed on user interface 112. In this scenario, plugin processor 114 may modify the HTML DOM to include an HTML element to select a new communication functionality from a plurality of communication functionalities. Next, plugin processor 114 may include code in the HTML stanza that causes a user interface to display the new communication functionality, such as telephony functionality, based on the plugin and/or the received message.

The new communication functionality, telephony functionality, may be a display of a user-selectable dial pad icon and may also include the sender's telephone number. In another example, plugin processor 114 may modify the HTML DOM to remove a communication functionality, such as text functionality in user interface 112, and only allow a telephony functionality.

In another example, plugin processor 114 may modify the message content to modify the word “call” by making it a user-selectable icon that, when selected, causes a telephone application to launch on client device 110.

In another example, plugin processor 114 may modify message metadata to change the sender of the recipient, if, for example, a CEO asked her assistant to send a message on her behalf and the CEO would like the recipient to call her on her direct phone line. In this example, plugin processor 114 may modify the “from” field to indicate that the message was from the CEO and not her assistant. This modification may also cause a change in the HTML stanza to include a CEO's direct phone number in a dial pad icon or a URL rather than her assistant's direct line.

The plugin may also consider client device characteristics to determine whether to provide a new communication functionality. For example, a user might not want to call the sender if the user is on a mobile device in a roaming area. In this scenario, the plugin may determine that telephony functionality may be warranted based on the message, but refrain from providing that functionality in the user interface based on the client device characteristics.

Similar to step 809, at step 906, plugin processor 114 may determine that no additional extensions to the user interface 112 is necessary to display the telephony functionality in the user interface 112. If so, similar to step 813, plugin processor 114 transmits the custom HTML stanza to UI renderer 115.

Similar to step 814, at step 907, UI renderer 115 may generate a standard user interface file with the HTML stanza based on the standard rendering protocol by modifying a standard user interface file to include the custom HTML stanza. As discussed above, modifications to the standard user interface file may include adding a communication functionality (e.g. telephone functionality), removing a communication functionality, or other modifications to the user interface.

Similar to step 815, at step 908, after UI renderer 115 generates the standard user interface file, UI renderer 115 transmits the standard user interface file to user interface 112 for display on client device 118.

As discussed above, by providing the capability to recognize the need to change communication functionality and customizing this capability for specific contexts using a natural language inference plugin.

IV. History Redaction

For, e.g., compliance and regulatory purposes, all messages sent using IM server 130 may be automatically archived as message history in data and messaging database 150 for subsequent retrieval. However, this functionality could present a problem when the messages are subsequently retrieved. For example, some countries have certain laws or regulations that restrict certain information from being displayed, charging fines each time the information is displayed. For example, one country may restrict displaying information that identifies that a client has a bank account at a certain bank and/or a client's bank account number at the bank. If this information is transmitted in an IM message in a room, the company hosting the IM service may need to pay a fine. However, every time someone enters the room and retrieves the message history via a message history request, the company will be required to pay another fine.

To solve this problem, system 100 includes the ability to redact, or conceal from view without destroying, messages or portions of messages deemed inappropriate.

Where a submitted message is deemed to be inappropriate, the system administrators may be asked to stop this message from being retrieved by other users via a message history request. IM server 130 allows a system administrator to associate a redaction indicator (e.g. a redaction flag) with a message in data and messaging database 150 so that the message detail will not be retrieved as part of the historic messages in response to a message history request. The system administrator is able to set the redaction indicator for a message by sending an instruction to meta service 137 providing the message identifier and an indication to toggle the redaction indicator.

Initially, a user requests message history in user interface 112 either by joining a conversation or actively requesting historical, archived messages. After a message history request is received by user interface 112, user interface 112 transmits a message history request to messaging core 131. The message history request includes parameters such as a conversation identifier, a “from” timestamp, and a “to” timestamp. The conversation identifier is used to retrieve messages from a specific conversation. The “from” time stamp and “to” time stamp are used to retrieve all messages in between the two time periods.

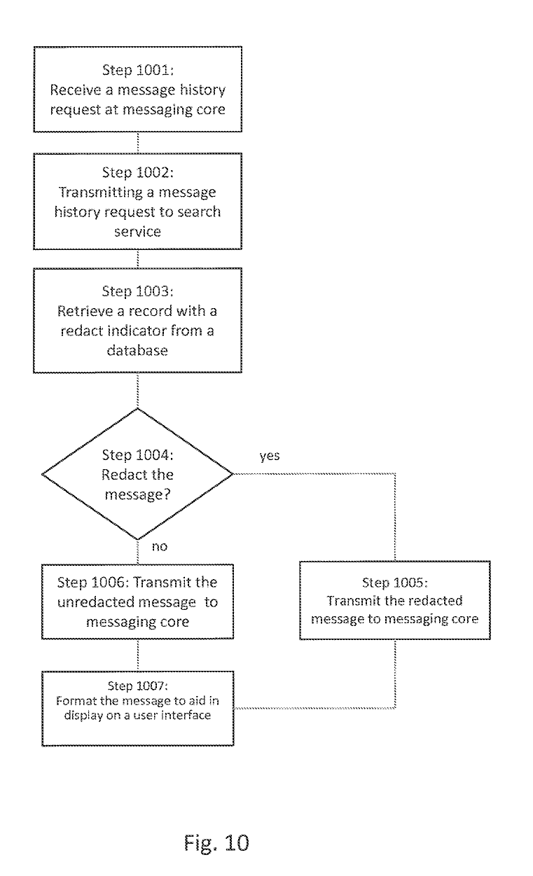

An exemplary implementation for message history redaction is discussed in reference to FIG. 10.

In FIG. 10, there is shown a flow diagram for a method redacting message history according to at least one embodiment of the invention.

At step 1001, messaging core 131 receives the message history request from user interface 112.

At step 1002, after messaging core 131 receives the message history request, messaging core 131 transmits an HTML “rest” call to search service 136.

At step 1003, after search service 136 receives the request from messaging core 131, search service 136 retrieves a one or more records from data and messaging database 150. First, search service 136 transmits a SQL query to data and messaging database 150 based on parameters in the message history request from messaging core 131, such as conversation identifier, a “from” timestamp, and a “to” timestamp. Then, search service 136 receives a record from data and messaging database 150 for a message that satisfies the parameters in the SQL query. The record also includes a redact indicator. The redact indicator indicates one of two states, a redact state and an unredact state.

At step 1004, search service 136 determines whether to redact the message by checking the redact indicator associated with the message and redacting the message if the redact indicator indicates that the message should be redacted.

If the redact indicator is in the redact state, the message is redacted.

If the redact indicator is in the unredact state, then the message is not redacted.

At step 1005, after search service 136 determines that the message should be redacted, search service 136 transmits the redacted message to messaging core 131. Examples of redacting may include redacting the whole message or a portion of a message, or redacting the sender name, among other types. To redact a portion of a message, a redact indicator may include a starting character offset and a length of redact. For example, to delete the word “Mike” from the message “Hi Mike,” the redact indictor would include a starting character offset of 3, because “M” is the third character, and a length of 4, because “Mike” is four characters.

At step 1006, after search service 136 determines that the message should not be redacted, search service 136 transmits the unredacted message to messaging core 131.

At step 1007, after messaging core 131 receives the messages from search service 136, messaging core 131 formats the messages to aid in display on user interface 112.

At step 1008, messaging core 131 transmits the message to user interface 112, where the message is displayed to the user.

V. General

The computers described herein generally include one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one.”

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

1. A computerized method comprising:
receiving data describing a request to obtain access to an instant messaging system from a requesting device, the request to obtain access including an identifier; and
identifying a plugin from a data repository based on the identifier in the request, the plugin being adapted to extend an instant messaging application installed on the requesting device.

2. The method of claim 1 further comprising:
transmitting, to the requesting device, data describing the plugin,
wherein the plugin is configured to extend the instant messaging application in accordance with a context of at least one of: a user of the instant messaging application, a party to a conversation, a conversation, a conversation type, a conversation member, and an instant messaging backend system.

3. The method of claim 2, wherein the plugin is configured to extend the instant messaging application by extending at least some messages sent or received by the instant messaging application based on an identity of an instant messaging backend system employed to process messages in connection with the instant messaging application.

4. The method of claim 2, wherein the request includes an identifier of the instant message backend system.

5. The method of claim 2, wherein the plugin is configured to extend the instant messaging application by extending at least some messages sent or received based on an identity of a user of the instant messaging application.

6. The method of claim 2, wherein the request includes an identifier of the user of the instant messaging application.

7. The method of claim 2, wherein the plugin is configured to extend the instant messaging application by extending at least some messages sent or received by the instant messaging application based on a conversation type.

8. The method of claim 2, wherein the request includes a conversation type identifier.

9. The method of claim 2, wherein conversation type is one of: a one-to-one conversation, non-persistent multiparty conversation or persistent multiparty conversation.

10. The method of claim 2, wherein the plugin is configured to extend the instant messaging application by extending at least some messages sent or received by the instant messaging application based on an identity of a persistent multiparty conversation.

11. The method of claim 2, wherein the request includes a persistent multiparty conversation identifier.

12. The method of claim 10, wherein the plugin is configured to extend the instant messaging application by extending at least some messages sent or received by the instant messaging application for a party in a persistent multiparty conversation based on a membership role of the party in the identified persistent multiparty conversation.

13. The method of claim 2, wherein the request includes a persistent multiparty conversation membership identifier.

14. The method of claim 2, wherein the plugin is configured to extend the instant messaging application by extending at least some messages sent or received by the instant messaging application from a counterparty in a conversation.

15. The method of claim 14, wherein the request includes a counterparty identifier associated with the counterparty in the conversation.

16. The method of claim 2, wherein the request includes an identifier of the user of the instant messaging application in the conversation.

17. The method of claim 1, wherein the identifier comprises data describing an end user.

18. The method of claim 1, further comprising receiving data describing the plugin at the requesting device.

19. The method of claim 1, further comprising extending the instant messaging application using the plugin.

20. The method of claim 1, wherein the plugin received during an instant messaging session extends the instant messaging application until the instant messaging session is terminated.

21. The method of claim 1, wherein the plugin is associated with a conversation using the instant messaging application and wherein the plugin is configured to extend the instant messaging application based on an identity of a counterparty in the conversation.

22. The method of claim 21, wherein the plugin is configured to extend the instant messaging application by extending at least some messages sent or received by the instant messaging application in the conversation.

23. The method of claim 21, wherein the request includes a counterparty identifier associated with the counterparty.

24. The method of claim 21, wherein the request includes an identifier associated with a user of the instant messaging application.

25. A computerized method comprising:
receiving data describing a request from a requesting device to access data describing messages initiated by one or more devices in connection with a message transmission channel implemented in an instant messaging application, the request including an identifier; and
identifying a plugin from a data repository based on the identifier in the request, the plugin being adapted to extend the instant messaging application installed on the requesting device.

26. The method of claim 25, further comprising:
transmitting, to the requesting device, data describing the plugin,
wherein the plugin is configured to extend the instant messaging application in accordance with a context of at least one of: a user of the instant messaging application, a party to a conversation, a conversation, a conversation type, a conversation member, and an instant messaging backend system.

27. The method of claim 26, wherein the request is a request to receive data describing messages initiated by a counterparty device and wherein the data describing the messages initiated by the counterparty device are associated with a counterparty identifier.

28. The method of claim 26, wherein the identifier comprises data describing a counterparty.

29. The method of claim 26, wherein the identifier comprises data describing an address associated with the message transmission channel.

30. The method of claim 26, wherein the identifier comprises data describing a user of the requesting device.

31. The method of claim 26, wherein the identifier comprises data describing the requesting device executing the instant messaging application.

32. The method of claim 26, further comprising receiving data describing the plugin at the requesting device.

33. The method of claim 26, further comprising extending the instant messaging application using the plugin.

34. The method of claim 26, wherein the plugin extends the instant messaging application until access to data describing messages initiated by the one or more devices in connection with the message transmission channel is terminated.

35. A system comprising:
one or more memory units each operable to store at least one program; and
at least one processor communicatively coupled to the one or more memory units, in which the at least one program, when executed by the at least one processor, causes the at least one processor to perform a method comprising:
receiving data describing a request to obtain access to an instant messaging system from a requesting device, the request to obtain access including an identifier; and
identifying a plugin from a data repository based on the identifier in the request, the plugin being adapted to extend an instant messaging application installed on the requesting device.

36. The system of claim 35 wherein the method further comprises:
transmitting, to the requesting device, data describing the plugin,
wherein the plugin is configured to extend the instant messaging application in accordance with a context of at least one of: a user of the instant messaging application, a party to a conversation, a conversation, a conversation type, a conversation member, and an instant messaging backend system.

37. A non-transitory computer readable storage medium having stored thereon computer-executable instructions which, when executed by a processor, perform a method comprising:
receiving data describing a request to obtain access to an instant messaging system from a requesting device, the request to obtain access including an identifier; and
identifying a plugin from a data repository based on the identifier in the request, the plugin being adapted to extend an instant messaging application installed on the requesting device.

38. The non-transitory computer readable storage medium of claim 37, wherein the method further comprises:
transmitting, to the requesting device, data describing the plugin,
wherein the plugin is configured to extend the instant messaging application in accordance with a context of at least one of: a user of the instant messaging application, a party to a conversation, a conversation, a conversation type, a conversation member, and an instant messaging backend system.

39. A system comprising:
one or more memory units each operable to store at least one program; and
at least one processor communicatively coupled to the one or more memory units, in which the at least one program, when executed by the at least one processor, causes the at least one processor to perform a method comprising:
receiving data describing a request from a requesting device to access data describing messages initiated by one or more devices in connection with a message transmission channel implemented in an instant messaging application, the request including an identifier; and
identifying a plugin from a data repository based on the identifier in the request, the plugin being adapted to extend the instant messaging application installed on the requesting device.

40. The system of claim 39, wherein the method further comprises:
transmitting, to the requesting device, data describing the plugin,
wherein the plugin is configured to extend the instant messaging application in accordance with a context of at least one of: a user of the instant messaging application, a party to a conversation, a conversation, a conversation type, a conversation member, and an instant messaging backend system.

41. A non-transitory computer readable storage medium having stored thereon computer-executable instructions which, when executed by a processor, perform a method comprising:
receiving data describing a request from a requesting device to access data describing messages initiated by one or more devices in connection with a message transmission channel implemented in an instant messaging application, the request including an identifier; and
identifying a plugin from a data repository based on the identifier in the request, the plugin being adapted to extend the instant messaging application installed on the requesting device.

42. The non-transitory computer readable storage medium of claim 41, wherein the method further comprises:
transmitting, to the requesting device, data describing the plugin,
wherein the plugin is configured to extend the instant messaging application in accordance with a context of at least one of: a user of the instant messaging application, a party to a conversation, a conversation, a conversation type, a conversation member, and an instant messaging backend system.

43. The system of claim 35, wherein the plugin is configured to extend the instant messaging application based on an identity of a counterparty in the conversation.

44. The non-transitory computer readable storage medium of claim 37 wherein the plugin is associated with a conversation using an instant messaging application and is configured to extend the instant messaging application based on an identity of a counterparty in the conversation.

45. A computerized method comprising:
transmitting, from a requesting device, data describing a request to obtain access to an instant messaging system, the request to obtain access including an identifier:
receiving, at the requesting device, a plugin identified from a data repository based on the identifier in the request; and
extending an instant messaging application installed on the requesting device based on the plugin.

46. The method of claim 45, wherein the plugin is configured to extend the instant messaging application in accordance with a context of at least one of: a user of the instant messaging application, a party to a conversation, a conversation, a conversation type, a conversation member, and an instant messaging backend system.

47. The method of claim 46, wherein the plugin is configured to extend the instant messaging application by extending at least some messages sent or received by the instant messaging application based on an identity of an instant messaging backend system employed to process messages in connection with the instant messaging application.

48. The method of claim 46, wherein the request includes an identifier of the instant message backend system.

49. The method of claim 46, wherein the plugin is configured to extend the instant messaging application by extending at least some messages sent or received based on an identity of a user of the instant messaging application.

50. The method of claim 46, wherein the request includes an identifier of the user of the instant messaging application.

51. The method of claim 46, wherein the plugin is configured to extend the instant messaging application by extending at least some messages sent or received by the instant messaging application based on a conversation type.

52. The method of claim 46, wherein the request includes a conversation type identifier.

53. The method of claim 46, wherein conversation type is one of: a one-to-one conversation, non-persistent multiparty conversation or persistent multiparty conversation.

54. The method of claim 46, wherein the plugin is configured to extend the instant messaging application by extending at least some messages sent or received by the instant messaging application based on an identity of a persistent multiparty conversation.

55. The method of claim 46, wherein the request includes a persistent multiparty conversation identifier.

56. The method of claim 46, wherein the plugin is configured to extend the instant messaging application by extending at least some messages sent or received by the instant messaging application for a party in a persistent multiparty conversation based on a membership role of the party in the identified persistent multiparty conversation.

57. The method of claim 46, wherein the request includes a persistent multiparty conversation membership identifier.

58. The method of claim 46, wherein the plugin is configured to extend the instant messaging application by extending at least some messages sent or received by the instant messaging application from a counterparty in a conversation.

59. The method of claim 46, wherein the request includes a counterparty identifier associated with the counterparty in the conversation.

60. The method of claim 46, wherein the request includes an identifier of the user of the instant messaging application in the conversation.

61. The method of claim 45, wherein the identifier comprises data describing an end user.

62. The method of claim 45, wherein the plugin received during an instant messaging session extends the instant messaging application until the instant messaging session is terminated.

63. A computerized method comprising:
transmitting, from a requesting device, data describing a request to access data describing messages initiated by one or more devices in connection with a message transmission channel implemented in an instant messaging application, the request including an identifier;
receiving, at the requesting device, a plugin identified from a data repository based on the identifier in the request; and
extending, at the requesting device, the instant messaging application installed on the requesting device.

64. The method of claim 63, wherein the plugin is configured to extend the instant messaging application in accordance with a context of at least one of: a user of the instant messaging application, a party to a conversation, a conversation, a conversation type, a conversation member, and an instant messaging backend system.

65. The method of claim 63, wherein the request is a request to receive data describing messages initiated by a counterparty device and wherein the data describing the messages initiated by the counterparty device are associated with a counterparty identifier.

66. The method of claim 63, wherein the identifier comprises data describing a counterparty.

67. The method of claim 63, wherein the identifier comprises data describing an address associated with the message transmission channel.

68. The method of claim 63, wherein the identifier comprises data describing a user of the requesting device.

69. The method of claim 63, wherein the identifier comprises data describing the requesting device executing the instant messaging application.

70. The method of claim 63, wherein the plugin extends the instant messaging application until access to data describing messages initiated by the one or more devices in connection with the message transmission channel is terminated.

71. A system comprising:
one or more memory units each operable to store at least one program; and
at least one processor communicatively coupled to the one or more memory units, in which the at least one program, when executed by the at least one processor, causes the at least one processor to perform a method comprising:
transmitting, from a requesting device, data describing a request to obtain access to an instant messaging system the request to obtain access including an identifier;
receiving, at the requesting device, a plugin identified from a data repository based on the identifier in the request; and
extending an instant messaging application installed on the requesting device based on the plugin.

72. The system of claim 71, wherein the plugin is configured to extend the instant messaging application in accordance with a context of at least one of: a user of the instant messaging application, a party to a conversation, a conversation, a conversation type, a conversation member, and an instant messaging backend system.

73. A non-transitory computer readable storage medium having stored thereon computer-executable instructions which, when executed by a processor, perform a method comprising:
transmitting, from a requesting device, data describing a request to obtain access to an instant messaging system the request to obtain access including an identifier;
receiving, at the requesting device, a plugin identified from a data repository based on the identifier in the request; and
extending an instant messaging application installed on the requesting device based on the plugin.

74. The non-transitory computer readable storage medium of claim 73 wherein the plugin is configured to extend the instant messaging application in accordance with a context of at least one of: a user of the instant messaging application, a party to a conversation, a conversation, a conversation type, a conversation member, and an instant messaging backend system.

75. A system comprising:
one or more memory units each operable to store at least one program; and
at least one processor communicatively coupled to the one or more memory units, in which the at least one program, when executed by the at least one processor, causes the at least one processor to perform a method comprising:
transmitting, from a requesting device, data describing a request to access data describing messages initiated by one or more devices in connection with a message transmission channel implemented in an instant messaging application, the request including an identifier;
receiving, at the requesting device, a plugin identified from a data repository based on the identifier in the request; and
extending, at the requesting device, the instant messaging application installed on the requesting device.

76. The system of claim 75, wherein the plugin is configured to extend the instant messaging application in accordance with a context of at least one of: a user of the instant messaging application, a party to a conversation, a conversation, a conversation type, a conversation member, and an instant messaging backend system.

77. A non-transitory computer readable storage medium having stored thereon computer-executable instructions which, when executed by a processor, perform a method comprising:
transmitting, from a requesting device, data describing a request to access data describing messages initiated by one or more devices in connection with a message transmission channel implemented in an instant messaging application, the request including an identifier;
receiving, at the requesting device, a plugin identified from a data repository based on the identifier in the request; and
extending, at the requesting device, the instant messaging application installed on the requesting device.

78. The non-transitory computer readable storage medium of claim 77 wherein the plugin is configured to extend the instant messaging application in accordance with a context of at least one of: a user of the instant messaging application, a party to a conversation, a conversation, a conversation type, a conversation member, and an instant messaging backend system.

79. The method of claim 45, wherein the plugin is configured to extend the instant messaging application based on an identity of a counterparty in the conversation.

80. The method of claim 79, wherein the plugin is configured to extend the instant messaging application by extending at least some messages sent or received by the instant messaging application in the conversation.

81. The method of claim 79, wherein the request to download the plugin includes a counterparty identifier associated with the counterparty.

82. The method of claim 79, wherein the request to download the plugin includes an identifier associated with a user of the instant messaging application.

83. The system of claim 71, wherein the plugin is configured to extend the instant messaging application based on an identity of a counterparty in the conversation.

84. The system of claim 75, wherein the plugin is configured to extend the instant messaging application based on an identity of a counterparty in the conversation.

85. A non-transitory computer readable storage medium of claim 73, wherein the plugin is configured to extend the instant messaging application based on an identity of a counterparty in the conversation.

86. A non-transitory computer readable storage medium of claim 77, wherein the plugin is configured to extend the instant messaging application based on an identity of a counterparty in the conversation.
